(19) United States
(12) Patent Application Publication
(10) Pub. No.: US 2026/0179480 A1
(43) Pub. Date: Jun. 25, 2026

(54) VALIDATION OF ROAD CLOSURE EVENTS ON ROAD SEGMENTS USING TRIP DATA

(71) Applicant: HERE Global B.V., Eindhoven (NL)

(72) Inventors: Jingwei XU, Buffalo Grove, IL (US); Weimin HUANG, Chicago, IL (US); Yuxin GUAN, Chicago, IL (US); Bruce BERNHARDT, Wauconda, IL (US)

(21) Appl. No.: 18/990,720

(22) Filed: Dec. 20, 2024

(51) Int. Cl. G08G 1/01; G08G 1/052

(52) U.S. Cl. CPC G08G 1/0133; G08G 1/0112; G08G 1/052

(57) ABSTRACT

A system for validation of road closure events on road segments based on trip data is provided. The system obtains first road closure event data associated with a road closure event on a road segment. The system further determines a first polygon to encompass at least one portion of the road segment based on the first road closure event data and map data associated with the road segment. The system further obtains first trip data based on the first road closure event data. The system further extracts second trip data from the first trip data. The system further outputs a first result based on the extracted second trip data and the determined first polygon. The first result is indicative of an occurrence of the road closure event in the at least one portion of the road segment.

### TECHNICAL FIELD

The disclosure relates to the validation of road closure events on a road segment, and more specifically, a system and a method for validation of road closure events using the trip data.

### BACKGROUND

Road closure events (such as accidents, construction events, and poor weather conditions) in a geographical region can significantly impact the driving experience of users of vehicles. For example, the road closure events may lead to an increase in an estimated arrival time for the vehicles traveling in the geographical region. In another example, the road closure events may further increase challenges associated with a route planning for a destination of the vehicles. To mitigate the challenges associated with the road closure events, various road closure warning systems have been widely employed for the vehicles. Such road closure warning systems can obtain road closure event data to determine the occurrence of the road closure events in the geographical region. The road closure warning systems can obtain the road closure event data from various sources such as one or more sensors employed with the vehicles, traffic agencies (such as a department of transportation (DOT)), automatic road closure (ACD) systems, an automatic road verification (ACV) system, an allgemeiner deutscher automobile-club (ADAC), or a police department). The road closure warning systems can further generate an alert to indicate the occurrence of the road closure event in the geographical region. The generation of the alerts allows the users of the vehicles to take counter-measures for the road closure events. The counter-measures include a route determination operation, a speed control operation, a safe location determination operation, and the like.

However, various sources may generate false road closure event data (such as false negative reports for the road closure events), leading to a distribution of the false road closure data. Such sources may generate the false road closure event data due to various challenges associated with the determination of the road closure events in the geographical region. For example, such systems can generate the false road closure data due to limitations associated with a computational complexity for determining the road closure events on each road segment in the geographical region. In another example, a miscommunication of the road closure events between the traffic agencies can lead to the generation of the false road closure data. Moreover, anomalies (such as hardware failures, and low transmission speed) associated with the one or more sensors may lead to the generation of the false road closure data. Additionally, the accuracy of the output of the road closure warning systems can decrease due to utilization of the false road closure event data for the determination of the road closure events. For example, the road closure events warning systems can generate incorrect alerts for the road closure events, leading to an inconvenience for the users of the vehicles.

Hence, there is a need to validate the road closure event data to overcome the aforementioned challenges associated with the performance of road closure warning systems.

### SUMMARY

A system, a method, and a computer programmable product are provided for the validation of road closure events on road segments based on trip data.

In one aspect, a system for validation of road closure events on road segments based on trip data is disclosed. The system includes a memory to store computer-executable instructions and one or more processors coupled to the memory. The one or more processors are configured to obtain first road closure event data from one or more sources. The first road closure event data is associated with a road closure event on a road segment. The one or more processors are further configured to determine a first polygon to encompass at least one portion of the road segment based on the first road closure event data and map data associated with the road segment. The one or more processors are further configured to obtain first trip data based on the first road closure event data. The first road closure event data is associated with a first set of trips taken by a set of vehicles traveling on the road segment. Each trip of the first set of trips is associated with the road segment. The one or more processors are further configured to extract second trip data from the first trip data. The second trip data is associated with a second set of trips. Each trip of the second set of trips is associated with the at least one portion of the road segment. The one or more processors are further configured to output a first result based on the extracted second trip data and the determined first polygon. The first result is indicative of an occurrence of the road closure event in the at least one portion of the road segment.

In additional system embodiments, the one or more processors are further configured to apply a set of geometric operations on the extracted second trip data and the determined first polygon. The one or more processors are further configured to determine the first trajectory data based on the application of the set of geometric operations on the extracted second trip data and the determined first polygon. The first trajectory data is associated with a first set of trajectories of the set of vehicles. Each trajectory of the first set of trajectories is associated with the at least one portion of the road segment. The one or more processors are further configured to determine validation data associated with the road closure event on the road segment based on the first trajectory data. The one or more processors are further configured to validate the first road closure event data based on a comparison of the first road closure event data with the validation data. The one or more processors are further configured to determine the first result based on the validation of the first road closure event data.

In additional system embodiments, the one or more processors are further configured to generate a shape file based on the determined first polygon. The shape file includes a set of geometry attributes associated with a geometry of the determined first polygon. The one or more processors are further configured to determine the first trajectory data based on an application of the set of geometric operations on the extracted second trip data and the set of geometry attributes.

In additional system embodiments, the set of geometric operations includes at least one of a polygon geometry overlay operation, a spatial join operation, or an intersection operation.

In additional system embodiments, the one or more processors are further configured to determine a first confidence score associated with the first result based on at least the first trajectory data. The first confidence score is indicative of a likelihood that the first result is correct. The one or more processors are further configured to output the first result based on a comparison of the first confidence score with a predefined confidence score.

In additional system embodiments, the one or more processors are further configured to determine first trajectory data based on the application of the set of geometric operations on the extracted second trip data and the determined first polygon. The first trajectory data is associated with a first set of trajectories of the set of vehicles. The one or more processors are further configured to determine an intermediate result for a first time period based on the first trajectory data. The intermediate result is indicative of an occurrence of the trajectories in the at least one portion of the road segment for a first time period. The one or more processors are further configured to determine the first result based on the determination that the intermediate result is indicative of an absence of the trajectories in the at least one portion of the road segment for the first time period. The first result is indicative of a presence of the road closure event in the at least one portion of the road segment for the first time period.

In additional system embodiments, the one or more processors are further configured to determine a first percentage based on the determination that the first result is indicative of the presence of the road closure event in the at least one portion of the road segment for the first time period. The first percentage is indicative of an area associated with the at least one portion of the road segment.

In additional system embodiments, the one or more processors are further configured to determine the first percentage based on the first trajectory data. The first trajectory data includes at least one of a count of trajectories in the first set of trajectories, a location of each vehicle of the set of vehicles in the at least one portion of the road segment, temporal data associated with each trajectory of the first set of trajectories, or a speed of each vehicle of the set of vehicles on the at least one portion of the road segment.

In additional system embodiments, the one or more processors are further configured to determine the first result indicative of an absence of the road closure event in the at least one portion of the road segment for the first time period based on the determination of that the intermediate result is indicative of a presence of the trajectories in the at least one portion of the road segment for the first time period.

In another aspect, a method for validation of road closure events on road segments based on trip data is disclosed. The method includes obtaining first road closure event data associated with a road closure event on a road segment from one or more sources. The method further includes determining a first polygon to encompass at least one portion of the road segment based on the first road closure event data and map data associated with the road segment. The method further includes obtaining first trip data associated with a first set of trips taken by a set of vehicles traveling on the road segment based on the first road closure event data. Each trip of the first set of trips is associated with the road segment. The method further includes extracting second trip data associated with a second set of trips from the first trip data. Each trip of the second set of trips is associated with the at least one portion of the road segment. The method further includes outputting a first result based on the extracted second trip data and the determined first polygon. The first result is indicative of an occurrence of the road closure event in the at least one portion of the road segment.

In additional methods, the method further includes applying a set of geometric operations on the extracted second trip data and the determined first polygon. The method further includes determining first trajectory data associated with a first set of trajectories of the set of vehicles based on the application of the set of geometric operations on the extracted second trip data and the determined first polygon. Each trajectory of the first set of trajectories is associated with the at least one portion of the road segment. The method further includes determining validation data associated with the road closure event on the road segment based on the first trajectory data. The method further includes validating the first road closure event data based on a comparison of the first road closure event data with the validation data. The method further includes determining the first result based on the validation of the first road closure event data.

In additional methods, the method further includes generating a shape file based on the determined first polygon. The shape file includes a set of geometry attributes associated with a geometry of the determined first polygon. The method further includes determining the first trajectory data based on an application of the set of geometric operations on the extracted second trip data and the set of geometry attributes.

In additional methods, the set of geometric operations includes at least one of a polygon geometry overlay operation, a spatial join operation, or an intersection operation.

In additional methods, the method further includes determining a first confidence score associated with the first result based on at least the first trajectory data. The first confidence score is indicative of a likelihood that the first result is correct. The method further includes outputting the first result based on a comparison of the first confidence score with a predefined confidence score.

In additional methods, the method further includes determining an intermediate result for a first time period based on the first trajectory data. The intermediate result is indicative of an occurrence of the trajectories in the at least one portion of the road segment for a first time period. The method further includes determining the first result based on the determination that the intermediate result is indicative of an absence of the trajectories in the at least one portion of the road segment for the first time period. The first result is indicative of a presence of the road closure event in the at least one portion of the road segment for the first time period.

In additional methods, the method further includes determining a first percentage indicative of an area associated with the at least one portion of the road segment based on the determination that the first result is indicative of the presence of the road closure event in the at least one portion of the road segment for the first time period.

In additional methods, the method further includes determining the first percentage based on the first trajectory data. The first trajectory data includes at least one of a count of trajectories in the first set of trajectories, a location of each vehicle of the set of vehicles in the at least one portion of the road segment, temporal data associated with each trajectory of the first set of trajectories, or a speed of each vehicle of the set of vehicles on the at least one portion of the road segment.

In additional methods, the method further includes determining the first result indicative of an absence of the road closure event in the at least one portion of the road segment for the first time period based on the determination of that the intermediate result is indicative of a presence of the trajectories in the at least one portion of the road segment for the first time period.

In yet another aspect, a non-transitory computer-readable storage medium having computer program code instructions stored therein, the computer program code instructions, when executed by one or more processors, cause the one or more processors to obtain first road closure event data associated with a road closure event on a road segment from one or more sources. The computer program code instructions, when executed by one or more processors, cause the one or more processors to determine a first polygon to encompass the road segment based on the first road closure event data and map data associated with the road segment. The computer program code instructions, when executed by one or more processors, cause the one or more processors to obtain first trip data associated with a first set of trips taken by a set of vehicles traveling on the road segment based on the first road closure event data. Each trip of the first set of trips is associated with the road segment. The computer program code instructions, when executed by one or more processors, cause the one or more processors to output a first result indicative of an occurrence of the road closure event on the road segment based on the first trip data and the determined first polygon.

In additional computer program product embodiments, the computer program code instructions, when executed by one or more processors, further cause the one or more processors to apply a set of geometric operations on the first trip data and the determined first polygon. The computer program code instructions, when executed by the one or more processors, further cause the one or more processors to determine first trajectory data based on an application of the set of geometric operations on the first trip data and the determined first polygon. The first trajectory data is associated with a first set of trajectories of the set of vehicles. Each trajectory of the first set of trajectories is associated with the road segment. The computer program code instructions, when executed by the one or more processors, further cause the one or more processors to determine validation data associated with the road closure event on the road segment based on the first trajectory data. The computer program code instructions, when executed by the one or more processors, further cause the one or more processors to validate the first road closure event data based on a comparison of the first road closure event data with the validation data. The computer program code instructions, when executed by the one or more processors, further cause the one or more processors to determine the first result based on the validation of the first road closure event data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the invention in general terms, reference will now be made to the accompanying drawings, which are not necessarily drawn to scale, and wherein:

FIG. 1 is a diagram that illustrates a network environment for validation of a road closure event on a road segment using trip data, in accordance with an embodiment of the disclosure;

FIG. 2 illustrates a block diagram of the system for validation of the road closure event on the road segment using trip data, in accordance with an embodiment of the disclosure;

FIG. 3 is a block diagram that illustrates an exemplary first set of operations for validation of the road closure event on the road segment using trip data, in accordance with an embodiment of the disclosure;

FIG. 4A is a diagram that depicts an exemplary first user interface associated with the operations for validation of the road closure event on the road segment, in accordance with an embodiment of the disclosure;

FIG. 4B is a diagram that depicts an exemplary second user interface associated with the operations for validation of road closure event on the road segment, in accordance with an embodiment of the disclosure;

FIG. 4C is a diagram that depicts an exemplary third user interface associated with the operations for validation of the road closure event on the road segment, in accordance with an embodiment of the disclosure;

FIG. 4D is a diagram that depicts an exemplary fourth user interface associated with the operations for validation of the road closure event on the road segment, in accordance with an embodiment of the disclosure;

FIG. 4E is a diagram that depicts an exemplary fifth user interface associated with the operations for validation of the road closure event on the road segment, in accordance with an embodiment of the disclosure;

FIG. 5 is a block diagram that illustrates an exemplary second set of operations for validation of the road closure event on the road segment based on the trip data, in accordance with an embodiment of the disclosure;

FIG. 6A is a first exemplary scenario that depicts the road closure event associated with the road segment, in accordance with an embodiment of the disclosure;

FIG. 6B is a second exemplary scenario that depicts the road closure event associated with the at least one portion of the road segment, in accordance with an embodiment of the disclosure;

FIG. 6C is a third exemplary scenario that depicts the road closure event associated with the road segment, in accordance with an embodiment of the disclosure;

FIG. 6D is a fourth exemplary scenario that depicts the road closure event associated with the road segment, in accordance with an embodiment of the disclosure;

FIG. 7 is a flowchart that illustrates a first exemplary method for validation of the road closure event on the road segment using trip data, in accordance with an embodiment of the disclosure; and

FIG. 8 is a flowchart that illustrates a second exemplary method for validation of the road closure event on the road segment using the trip data, in accordance with an embodiment of the disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received, and/or stored in accordance with embodiments of the present disclosure. Thus, use of any such terms should not be taken to limit the spirit and scope of embodiments of the present disclosure.

As defined herein, a “computer-readable storage medium,” which refers to a non-transitory physical storage medium (for example, a volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the description and should not be regarded as limiting. Any heading utilized within this description is for convenience only and has no legal or limiting effect.

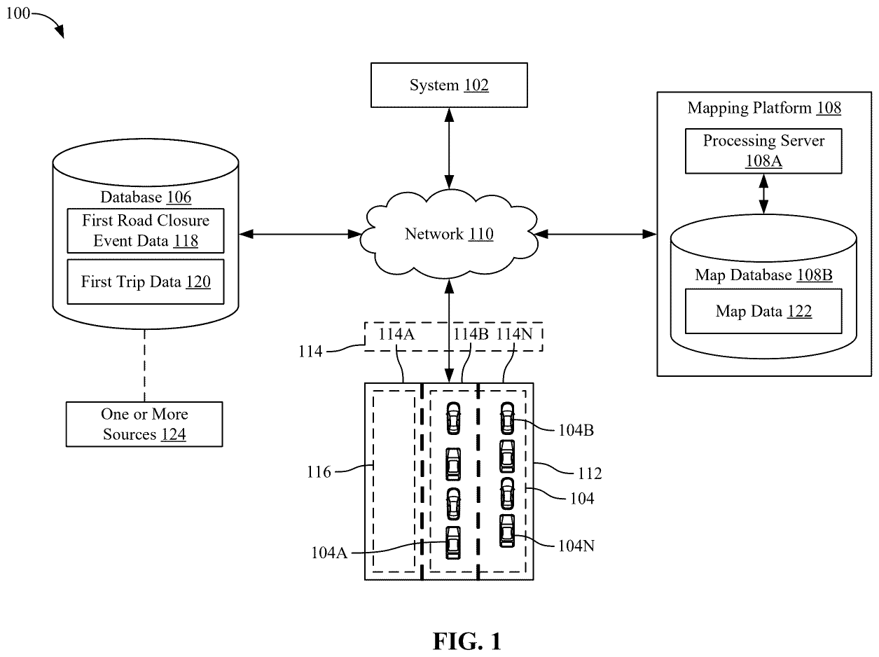

FIG. 1 is a diagram that illustrates a network environment for validation of a road closure event on a road segment using trip data, in accordance with an embodiment of the disclosure. With reference to FIG. 1, there is shown a diagram of the network environment 100. The network environment 100 includes a system 102, a set of vehicles 104, a database 106, and a mapping platform 108. The network environment 100 may further include a network 110. With reference to FIG. 1, there is further shown, a road segment 112 and may include a set of lane segments 114. The set of vehicles 104 may be traveling on the road segment 112 and may include a first vehicle 104A, a second vehicle 104B, up to an Nth vehicle 104N. The mapping platform 108 may include a processing server 108A and a map database 108B. The set of lane segments 114 may include a first lane segment 114A, a second lane segment 114B, a third lane segment 114C, up to an Nth lane segment 114N. In an embodiment, the system 102 may be associated with the first vehicle 104A of the set of vehicles 104. In another embodiment, the system 102 may be integrated within the first vehicle 104A of the set of vehicles 104.

In an embodiment, the database 106 may be configured to store first road closure event data 118, and first trip data 120. The first road closure event data 118 may be associated with a road closure event (such as accidents, construction events, poor weather conditions, and the like) on the road segment 112. Further, the first trip data 120 may be associated with a first set of trips taken by the set of vehicles 104 traveling on the road segment 112. In an embodiment, the map database 108B may be configured to store map data 122 associated with the road segment 112.

The system 102 may include suitable logic, circuitry, interfaces, and/or code that may be configured to validate the road closure events on the road segment 112 using the trip data (such as the first trip data 120). In an embodiment, the system 102 may be configured to obtain the first road closure event data 118 from one or more sources 124. The first road closure event data 118 may be associated with the road closure event on the road segment 112. The system 102 may be further configured to determine a first polygon 116 to encompass at least one portion of the road segment 112 based on the first road closure event data 118 and the map data 122. In an embodiment, the one portion of the road segment 112 corresponds to the first lane segment 114A. The system 102 may be further configured to obtain the first trip data 120 based on the first road closure event data 118. The first trip data 120 may be associated with the first set of trips taken by the set of vehicles 104 traveling on the road segment 112. Each trip of the first set of trips may be associated with the road segment 112. The system 102 may be further configured to extract second trip data from the first trip data 120. The second trip data may be associated with a second set of trips. Each trip of the second set of trips may be associated with the at least one portion of the road segment 112. The system 102 may be configured to output a first result based on the extracted second trip data and the determined first polygon 116. The first result may be indicative of an occurrence of the road closure event in the at least one portion of the road segment 112. Examples of the system 102 may include, but are not limited to, an electronic control unit (ECU) of the first vehicle 104A, an electronic control module (ECM) of the first vehicle 104A, a computing device, a mainframe machine, a server, a computer workstation, any and/or any other device associated with road closure data validation operations.

For example, the system 102 may be on-boarded by the first vehicle 104A, such as the system 102 may be a stand-alone road closure data validation system for validating the first road closure event data 118. In another example, the system 102 may be the processing server 108A of the mapping platform 108 and therefore may be co-located with or within the mapping platform 108.

In another embodiment, the system 102 may be embodied as a cloud-based service, a cloud-based application, a cloud-based platform, a remote server-based service, a remote server-based application, a remote server-based platform, or a virtual computing system. In yet another example, the system 102 may be an OEM (Original Equipment Manufacturer) cloud. The OEM cloud may be configured to anonymize any data received by the system 102, such as the first road closure event data 118, the first trip data 120, or the map data 122, before using the data for further processing, such as before sending the data to the map database 108B. For example, anonymization of the data may be done by the mapping platform 108.

Each vehicle of the set of vehicles 104 may be a non-autonomous vehicle, a semi-autonomous vehicle, or a fully autonomous vehicle, for example, as defined by the National Highway Traffic Safety Administration (NHTSA). Examples of each vehicle of the set of vehicles 104 may include, but are not limited to, a two-wheeler vehicle, a three-wheeler vehicle, a four-wheeler vehicle, more than a four-wheeler vehicle, a hybrid vehicle, or a vehicle with autonomous drive capability that uses one or more distinct renewable or non-renewable power sources. The vehicle that uses renewable or non-renewable power sources may include a fossil fuel-based vehicle, an electric propulsion-based vehicle, a hydrogen fuel-based vehicle, a solar-powered vehicle, and/or a vehicle powered by other forms of alternative energy sources. Each vehicle of the set of vehicles 104 may be a system through which an occupant (for example a rider) may travel from a start point to a destination point. Examples of the two-wheeler vehicles may include, but are not limited to, an electric two-wheeler, an internal combustion engine (ICE)-based two-wheeler, or a hybrid two-wheeler. Similarly, examples of the four-wheeler vehicle may include, but are not limited to, an electric car, an internal combustion engine (ICE)-based car, a fuel-cell-based car, a solar powered-car, or a hybrid car. It may be noted here that the four-wheeler diagram of each of the set of vehicles 104 is merely shown as examples in FIG. 1. The present disclosure may also be applicable to other structures, designs, or shapes of each of the set of vehicles 104. The description of other types of vehicles and respective structures, designs, or shapes has been omitted from the disclosure for the sake of brevity.

In some examples, each vehicle of the set of vehicles 104 may include processing means such as a central processing unit (CPU), storage means such as on-board read-only memory (ROM), random access memory (RAM), acoustic sensors such as a microphone array, position sensors such as a global positioning system (GPS) sensor, gyroscope, a light detection and ranging (LiDAR) sensor, a proximity sensor, motion sensors such as an accelerometer, an image sensor such as a camera, a display enabled user interface such as a touch screen display, and other components as may be required for specific functionalities of each vehicle of the set of vehicles 104. In some examples, a user equipment may be associated, coupled, or otherwise integrated with the set of vehicles 104, such as an advanced driver assistance system (ADAS), a personal navigation device (PND), a portable navigation device, and/or other devices that may be configured to provide route guidance and navigation-related functions to the user.

In an embodiment, each vehicle of the set of vehicles 104 may include an infotainment system. The infotainment system may include suitable logic, circuitry, interfaces, and/or code that may be configured to render at least audio-based data, or video-based data, on the user interface in the corresponding vehicle of the set of vehicles 104. For example, the infotainment system may include a display to display the user interface on which the video-based data may be displayed. In another example, the infotainment system may include a plurality of speakers to output the audio-based data. In such an example, the audio-based data may include, but is not limited to, audio content rendered on the plurality of speakers communicatively coupled to the user interface. The infotainment system may be configured to render the determined first result. Examples of the infotainment system may include, but are not limited to, an entertainment system, a navigation system, a vehicle user interface system, an Internet-enabled communication system, and other entertainment systems.

The database 106 may comprise suitable logic, circuits, and interfaces that may be configured to store the first road closure event data 118. The first road closure event data 118 may be associated with the road closure event on the road segment 112. In an embodiment of the disclosure, the first road closure event data 118 is collected from the one or more sources 124 associated with the road closure event. Examples of the one or more sources 124 associated with the road closure event include, but are not limited to, one or more sensors associated with the set of vehicles 104, traffic agencies (such as a department of transportation (DOT)), automatic road closure (ACD) systems, an automatic road verification (ACV) system, an allgemeiner deutscher automobile-club (ADAC), or a police department).

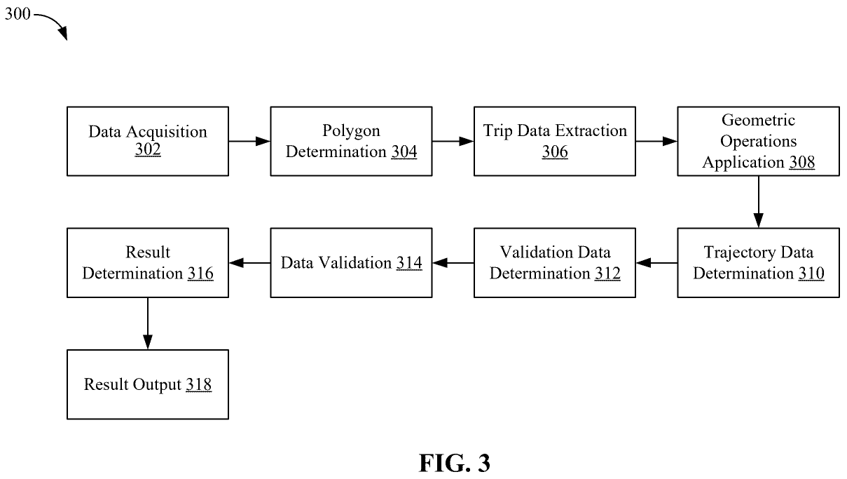

In an embodiment, the database 106 may be configured to store the first trip data 120. The first trip data 120 may be associated with the first set of trips taken by the set of vehicles 104 traveling on the road segment 112. Each trip of the first set of trips may be associated with the road segment 112 and may correspond to a respective portion of a first set of trajectories of the set of vehicles 104. Further, each trajectory of the first set of trajectories may be associated with the road segment 112. In an embodiment, the system 102 may be configured to apply map matching on the first trip data 120 and the map data 122. Further, the system 102 may be configured to determine each trip of the first set of trips based on the application of the map matching on the first trip data 120 and the map data 122. For example, a first trip of the first set of trips may correspond to a first portion of a first trajectory of the first set of trajectories. The first trajectory may be traversed by the first vehicle 104A on the road segment 112. In an embodiment, the first trip data 120 may include, but is not limited to, a start time for each trip of the first set of trips, an end time for each trip of the first set of trips, a first set of coordinates for each trip of the first set of trips, first temporal data associated with each trip of the first set of trips, and a speed of each vehicle of the set of vehicles 104 on each trip of the first set of trips. Details about the first trip data 120 are provided, for example, in FIG. 3.

The mapping platform 108 may comprise suitable logic, circuitry, and interfaces that may be configured to store the map data 122. The map data 122 may be associated with the road segment 112. In an embodiment, the map database 108B of the mapping platform 108 may be configured to store the map data 122. The map data 122 may include one or more map attributes associated with a map of the road segment 112 and sensor data associated with traffic on the set of lane segments 114. The mapping platform 108 may be configured to store and update the map data 122 indicating the traffic data along with other map attributes, road attributes, and traffic entities, in the map database 108B. The mapping platform 108 may include techniques related to, but not limited to, geocoding, routing (multimodal, intermodal, and unimodal), clustering algorithms, machine learning in location-based solutions, natural language processing algorithms, and artificial intelligence algorithms. Data for different modules of the mapping platform 108 may be collected using a plurality of technologies including, but not limited to drones, sensors, connected cars, cameras, probes, and chipsets. In some embodiments, the mapping platform 108 may be embodied as a chip or chip set. In other words, the mapping platform 108 may comprise one or more physical packages (such as chips) that include materials, components, and/or wires on a structural assembly (such as a baseboard).

In some examples, the mapping platform 108 may include the processing server 108A for carrying out the processing functions associated with the mapping platform 108 and the map database 108B for storing the map data 122. In an embodiment, the processing server 108A may include one or more processors configured to process requests received from the system 102. The processors may fetch the map data 122 from the map database 108B and transmit the same to the system 102 in a format suitable for use by the system 102.

Continuing further, the map database 108B may comprise suitable logic, circuitry, and interfaces that may be configured to store the map data 122, which may be collected from the first vehicle 104A. In accordance with an embodiment, such sensor data may be updated in real-time or near real-time such as within a few seconds, a few minutes, or on an hourly basis, to provide accurate and up-to-date sensor data. The sensor data may be collected from any sensor that may inform the mapping platform 108 or the map database 108B of features within an environment that is appropriate for traffic-related services. In accordance with an embodiment, the sensor data may be collected from any sensor that may inform the mapping platform 108 or the map database 108B of features within an environment that is appropriate for mapping. For example, motion sensors, inertia sensors, image capture sensors, proximity sensors, LiDAR sensors, and ultrasonic sensors may be used to collect the sensor data. The gathering of massive quantities of crowd-sourced data may facilitate the accurate modeling and mapping of an environment, whether it is a road link or a link within a structure, such as in an interior of a multi-level parking structure.

The map database 108B may further be configured to store the traffic-related data and road topology and geometry-related data for a road network as the map data 122. The map data 122 may also include cartographic data, routing data, and maneuver data. The map data 122 may also include, but is not limited to, locations of intersections, diversions to be caused due to accidents, congestions or constructions, suggested roads, or links to avoid, and an estimated time of arrival (ETA) depending on different links. In accordance with an embodiment, the map database 108B may be configured to receive the map data 122 including the road topology and geometry-related attributes related to the road network from external systems, such as one or more of background batch data services, streaming data services, and third-party service providers, via the network 110.

In accordance with an embodiment, the map data 122 stored in the map database 108B may further include data about changes in traffic situations registered by GPS provider(s), such as, but not limited to, incidents, road repairs, heavy rains, snow, fog, time of day, day of a week, holiday or other events which may influence the traffic condition of a link segment.

In some embodiments, the map database 108B may further store historical probe data for events (such as, but not limited to, traffic incidents, construction activities, scheduled events, and unscheduled events) associated with Point of Interest (POI) data records or other records of the map database 108B.

For example, the data (such as the map data 122) stored in the map database 108B may be compiled (such as into a platform specification format (PSF)) to organize and/or processed for generating navigation-related functions and/or services, such as route calculation, route guidance, map display, speed calculation, distance and travel time functions, navigation instruction generation, and other functions, by a navigation device, such as a user equipment. The navigation-related functions may correspond to vehicle navigation, pedestrian navigation, navigation to a favoured parking spot, or other types of navigation. While examples described herein generally relate to vehicular travel, examples may be implemented for bicycle travel along bike paths, boat travel along maritime navigational routes, etc. The compilation to produce the end-user databases may be performed by a party or entity separate from the map developer. For example, a customer of the map developer, such as a navigation device developer or other end user device developer, may perform compilation on the received map database 108B in a delivery format to produce one or more compiled navigation databases.

In some embodiments, the map database 108B may be a master geographic database configured on the side of the system 102. In accordance with an embodiment, the map database 108B may represent a compiled navigation database that may be used in or with end-user devices to provide navigation instructions based on the traffic data, the traffic conditions, speed adjustment, ETAs, and/or map-related functions to navigate through the intersection connected links on the route.

In some embodiments, the map data 122 may correspond to high definition (HD) map data that may be collected by end-user vehicles (such as the first vehicle 104A) which use vehicles on-board one or more sensors to detect data about various entities such as road objects, lane markings, links, and the like. These vehicles are also referred to as probe vehicles and form an alternate form of data source for map data 122 collection, along with ground truth data. Additionally, the HD map data collection mechanisms like remote sensing, such as aerial or satellite photography may be used to collect the map data 122 for the map database 108B. In an embodiment, the map database 108B may obtain the HD map data from the LIDAR sensors.

For example, the map data 122 stored in the map database 108B may include lane and intersection data records or other data that may represent links in the route, pedestrian lane, or areas in addition to or instead of the vehicle lanes. The lanes and intersections may be associated with attributes, such as geographic coordinates, street names, lane identifiers, lane segment identifiers, lane traffic direction, address ranges, speed limits, turn restrictions at intersections, and other navigation-related attributes, as well as POIs, such as fuelling stations, hotels, restaurants, museums, stadiums, offices, auto repair shops, buildings, stores, and parks. The map database 108B may additionally include data about places, such as cities, towns, or other communities, and other geographic features such as, but not limited to, bodies of water, and mountain ranges.

In some examples, images received from the image source may be stored within the map database 108B of the mapping platform 108. In certain cases, the mapping platform 108, using the processing server 108A, may suitably process the received images. For example, such processing may include, suitably labeling the images based on the corresponding associated lane and/or link, point of interest within the link and/or lane, and other information relating to the respective link and/or lane. Such labeled images may then be stored within the map database 108B as map data 122.

The network 110 may be wired, wireless, or any combination of wired and wireless communication networks, such as cellular, Wi-Fi, internet, local area networks, or the like. In some embodiments, the network 110 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or a fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (e.g. LTE-Advanced Pro), 5G New Radio networks, international telecommunication union (ITU)—international mobile communications (IMT) 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

In operation, the system 102 may be configured to obtain the first road closure event data 118 from the database 106. The first road closure event data 118 may be associated with the road closure event on the road segment. In an embodiment, the system 102 may utilize the first road closure event data 118 to indicate the occurrence of the road closure event on the road segment 112. In an embodiment, the first road closure event data 118 corresponds to historical first road closure event data. The historical first road closure event data may be associated with a historical time period (such as 2 hours, 3 days, 1 week, 1 month, or 1 year) with respect to the current date of operations of the system 102. The determination of the road closure event on the road segment 112 may allow users of the set of vehicles 104 to determine whether it is convenient to navigate via the road segment 112, leading to an enhancement in a driving experience of the users of the set of vehicles 104. However, the one or more sources 124 may generate false road closure event data (such as false negative reports for the road closure event on the road segment 112), leading to a distribution of the false road closure event data. The one or more sources 124 may generate the false road closure event data due to various challenges associated with the determination of the road closure event on the road closure event. For example, the ACD systems or the ACV systems may generate the false road closure event data due to limitations associated with a computational complexity for determining the road closure event on each lane segment of the set of lane segments 114. In another example, a miscommunication of the road closure event between the traffic agencies may lead to the generation of the false road closure event data. In yet another embodiment, anomalies (such as hardware failures, or a low transmission speed) associated with the one or more sensors may lead to the generation of the false road closure event data. Additionally, the system 102 may generate a false alert for the road closure event on the road segment 112 based on the false road closure event data. The generation of the false alert for the road closure event data may further lead to an inconvenience for the users of the set of vehicles 104 while driving the set of vehicles 104 on the road segment 112. In order to address the aforementioned challenges, the system 102 may be configured to validate the first road closure event data associated with the road closure event data on the road segment 112.

In an embodiment, the system 102 may be further configured to determine the first polygon 116 to encompass at least one portion (such as the lane segment 114) of the road segment 112 based on the first road closure event data 118 and the map data 122 associated with the road segment 112. In an embodiment, the first polygon 116 may correspond to a closed two-dimensional shape that includes a set of line segments connected end-to-end to form a closed chain. In an embodiment, the set of line segments may be referred to as “sides or edges.” In an embodiment, a point of intersection of at least two line segments of the set of line segments may be referred to as “vertices or corners.” Additionally, the first polygon 116 may include at least three line segments of the set of line segments and at least three angles corresponding to an intersection of the at least three-line segments. Examples of the first polygon include, but are not limited to, a triangle having 3 connected line segments, a quadrilateral having 4 connected line segments, and a pentagon having 5 connected line segments.

The system 102 may be further configured to obtain the first trip data 120 based on the first road closure event data 118. The first trip data 120 may be associated with the first set of trips taken by the set of vehicles 104 traveling on the road segment 112. Each trip of the first set of trips may be associated with the road segment 112. Details about the first road closure event data 118 are provided, for example, in FIG. 3. The system 102 may be further configured to extract second trip data from the first trip data 120. The second trip data may be associated with the second set of trips. Each trip of the second set of trips may be associated with the at least one portion (such as the lane segment 114) of the road segment 112. In an embodiment, each trip of the second set of trips may correspond to a respective portion of a second set of trajectories of the set of vehicles 104. Further, each trajectory of the second set of trajectories may be associated with the at least one portion of the road segment 112. For example, a second trip of the second set of trips may correspond to a second portion of a second trajectory of the second set of trajectories. The second trajectory may be traversed by the first vehicle 104A on the at least one portion (such as the first lane segment 114A) of the road segment 112.

The system 102 may be further configured to output the first result based on the extracted second trip data and the determined first polygon 116. The first result may be indicative of the occurrence of the road closure event in the at least one portion of the road segment 112. In an embodiment, the system 102 may be configured to determine the first result based on the validation of the first road closure event data 118. In an embodiment, the first result may correspond to a validation result for the occurrence of the road closure event on the road segment 112. In an embodiment, the system 102 may utilize the first result for an accurate prediction of one or more road closure events on the road segment 112. Additionally, the utilization of the first result increases an accuracy associated with the prediction of the one or more events, leading to an improved user experience for users of the set of vehicles 104. Details about the validation of the first road closure event data are provided, for example, in FIG. 3.

In an embodiment, the system 102 may be configured to output the first result on a user interface associated with the system 102. In another embodiment, the system 102 may be configured to render an audio output indicative of the first result. In yet another embodiment, the system 102 may be configured to store the first result in the map database 108B.

In an embodiment, the system 102 may be communicatively coupled to each vehicle of the set of vehicles 104, the database 106, and the mapping platform 108, via the network 110. In an embodiment, the system 102 may be communicatively coupled to other components not shown in FIG. 1 via the network 110. All the components in the network environment 100 may be coupled directly or indirectly to the network 110. The components described in the network environment 100 may be further broken down into more than one component and/or combined together in any suitable arrangement. Further, one or more components may be rearranged, changed, added, and/or removed.

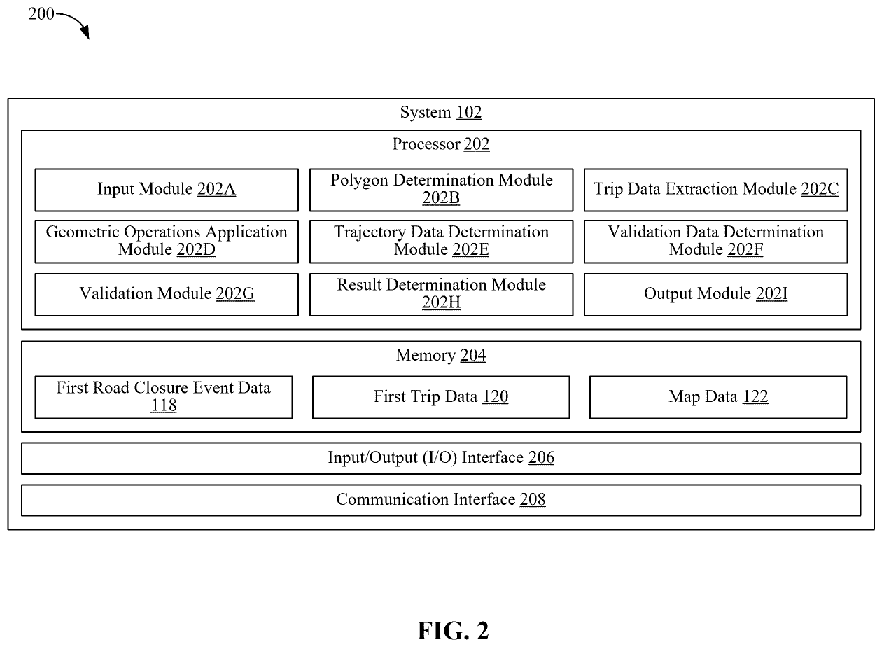

FIG. 2 illustrates a block diagram 200 of the system 102 for validation of road closure event on the road segment using trip data, in accordance with an embodiment of the disclosure. The system 102 may include at least one processor 202 (hereinafter, also referred to as “processor 202”), at least one memory 204 (hereinafter, also referred to as “memory 204”), at least one input/output (I/O) interface 206 (hereinafter, also referred to as “I/O interface 206”), and at least one communication interface 208 (hereinafter, also referred to as “communication interface 208”). The processor 202 may include modules, depicted as, an input module 202A, a polygon determination module 202B, a trip data extraction module 202C, a geometric operations application module 202D, a trajectory data determination module 202E, a validation data determination module 202F, a validation module 202G, a result determination module 202H, and an output module 202I. The system 102 may be connected to the memory 204, and the I/O interface 206 through wired or wireless connections. Although in FIG. 2, it is shown that the system 102 includes the processor 202, the memory 204, and the I/O interface 206 however, the disclosure may not be so limiting and the system 102 may include fewer or more components to perform the same or other functions of the system 102. In an embodiment, the input module 202A and the output module 202I may be integrated within the I/O interface 206. In some embodiments, the input module 202A may receive input data (such as the first road closure event data 118, the first trip data 120, and the map data 122), and the output module 202I may output processed data (such as the extracted second trip data, or the first result) via the I/O interface 206.

The processor 202 of the system 102 may be configured to validate the first road closure event data 118 and output the validated first road closure event data. The processor 202 may be embodied in a number of different ways. For example, the processor 202 may be embodied as one or more of various hardware processing means such as a coprocessor, a microprocessor, a controller, a digital signal processor (DSP), a processing element with or without an accompanying DSP, or various other processing circuitry including integrated circuits such as an ASIC (application specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. For example, the processor 202 may be in communication with the memory 204 via a bus for passing information among components of the system 102.

For example, when the processor 202 may be embodied as an executor of computer program code instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202. The network environment, such as 100 may be accessed using the communication interface 208 of the system 102. The communication interface 208 may provide an interface for accessing various features and data stored in the system 102.

In some embodiments, the processor 202 may be configured to provide Internet-of-Things (IoT) related capabilities to users of the system 102 disclosed herein. The IoT-related capabilities may in turn be used to provide smart navigation solutions and road closure event warnings to the users by validating the road closure event on the road segment 112 in near real-time. The road closure event warnings may allow the users to take pro-active decisions on turn maneuvers, lane changes, and the like. The IoT-related capabilities may further provide big data analysis, and sensor-based data collection by using the cloud-based mapping system for providing accurate navigation instructions and ensuring driver safety. The I/O interface 206 may provide an interface for accessing various features and data stored in the system 102.

The input module 202A of the processor 202 may be configured to obtain the first road closure event data 118. The first road closure event data 118 may be associated with the road closure event on the road segment 112. In an embodiment, the input module 202A of the processor may be configured to obtain the first trip data 120. The first trip data 120 may be associated with the first set of trips taken by the set of vehicles 104 traveling on the road segment 112. Each trip of the first set of trips may be associated with the road segment 112. Specifically, each trip of the first set of trips is taken on the road segment 112 by users of the set of vehicles 104. In an embodiment, each trip of the first set of trips may correspond to the respective portion of a first set of trajectories of the set of vehicles 104. Further, each trajectory of the first set of trajectories may be associated with the road segment 112. Specifically, each trajectory of the first set of trajectories is on the road segment 112. Details about the first trip data 120 are provided, for example, in FIG. 3. In another embodiment, the input module 202A of the processor 202 may be configured to obtain the map data 122. The map data 122 may include the one or more map attributes associated with the map of the road segment 112. Details about the map data 122 are provided, for example, in FIG. 1.

The polygon determination module 202B of the processor 202 may be configured to determine the first polygon 116 to encompass the at least one portion of the road segment 112 (such as the lane segment 114) based on the first road closure event data 118 and the map data 122. The map data 122 may be associated with the road segment 112. In an embodiment, the first polygon 116 may correspond to the closed two-dimensional shape that includes the set of line segments connected end-to-end to form the closed chain.

The trip data extraction module 202C of the processor 202 may be further configured to extract the second trip data from the first trip data 120. The second trip data may be associated with the second set of trips. Each trip of the second set of trips may be associated with the at least one portion of the road segment 112 (such as the first lane segment 114A). In an embodiment, each trip of the second set of trips may correspond to the respective portion of the second set of trajectories of the set of vehicles 104. Further, each trajectory of the second set of trajectories may be associated with the at least one portion of the road segment 112. In an embodiment, the second trip data may include, but is not limited to, a start time for each trip of the second set of trips, an end time for each trip of the second set of trips, a second set of coordinates for each trip of the second set of trips, second temporal data associated with each trip of the second set of trips, and a speed of each vehicle of the set of vehicles 104 on each trip of the second set of trips. Details about the second set of trips are provided, for example, in FIG. 3.

The geometric operations application module 202D of the processor 202 may be configured to apply a set of geometric operations on the extracted second trip data and the determined first polygon 116. In an embodiment, the set of geometric operations may include at least one of a polygon geometry overlay operation, a spatial join operation, or an intersection operation.

In the polygon geometry overlay operation, the system 102 may be configured to determine an overlapping of the first polygon 116 on each of the second set of coordinates. Further, the system 102 may be configured to determine the first trajectory data based on the overlapping of the first polygon 116 on each of the second set of coordinates. The first trajectory data may be associated with the first set of trajectories of the set of vehicles 104. Further, each trajectory of the first set of trajectories may be associated with the at least one portion of the road segment 112 (such as the first lane segment 114A of the road segment 112). In an embodiment, the system 102 may be configured to determine a location of each vehicle of the set of vehicles 104 in the at least one portion of the road segment 112 based on the overlapping of the first polygon 116 on each of the second set of coordinates. In another embodiment, the system 102 may be configured to determine temporal data associated with each trajectory of the first set of trajectories based on the overlapping of the first polygon 116 on each of the second set of coordinates. Further, the system 102 may be configured to determine the speed of each vehicle of the set of vehicles 104 on each trip of the second set of trips based on the location of each vehicle of the set of vehicles in the at least one portion of the road segment 112 and the temporal data associated with each trajectory of the first set of trajectories.

In the spatial join operation, the system 102 may be configured to correlate a set of geometry attributes associated with the first polygon 116 with the extracted second trip data. Further, the system 102 may be configured to determine the first trajectory data based on the correlation of the set of geometry attributes and the extracted second trip data. In an embodiment, the correlation may correspond to a mapping of at least one of the set of geometry attributes with at least one of the second set of coordinates. The second set of coordinates may be included in the extracted second trip data. In an embodiment, the system 102 may be configured to generate a shape file based on the determined first polygon 116. The shape file may include the set of geometry attributes associated with a geometry of the determined first polygon 116. In an embodiment, the set of geometry attributes may be associated with a number of sides (such as 3 sides, 4 sides, or 6 sides) associated with the determined first polygon 116, a length (such as 2 meters, 6 meters, or 10 meters) of each side of the determined first polygon 116, a set of angles (such as 30 degrees, 45 degrees or 70 degrees) associated with the determined first polygon 116, or a perimeter associated with the determined first polygon 116. In an embodiment, the perimeter associated with the determined first polygon 116 may be indicative of the total length (such as 10 meters, 20 meters, 30 meters, or 40 meters) of a boundary associated with the determined first polygon 116. For example, the system 102 may be configured to determine the first trajectory data based on the correlation of each of the second set of coordinates with a first length of a first side associated with the determined first polygon 116. Specifically, the system 102 may be configured to determine a count of trajectories in the first set of trajectories based on a mapping of each of the second set of coordinates with the first length of the first side of the determined first polygon 116. In an embodiment, the system 102 may be configured to determine the corresponding coordinates of the second set of coordinates for each vehicle of the set of vehicles 104. Further, the system 102 may be configured to determine the count of trajectories in the first set of trajectories based on a mapping of the corresponding coordinates for the set of vehicles 104 with the first length of the first side associated with the determined first polygon 116.

In an embodiment, in the intersection operation, the system 102 may be configured to determine an overlapping of each of the second set of coordinates with the perimeter associated with the determined first polygon 116. Further, the system 102 may be configured to determine the first trajectory data based on the overlapping of each of the second set of coordinates with the perimeter associated with the determined first polygon 116. Specifically, the system 102 may be configured to determine the temporal data associated with each trajectory of the first set of trajectories based on the overlapping of each of the second set of coordinates with the perimeter associated with the determined first polygon 116. The temporal data may be indicative of a starting time associated with a start point of each trajectory of the first set of trajectories. Further, the temporal data may be indicative of an ending time associated with an end point of each trajectory of the first set of trajectories.

The trajectory data determination module 202E of the processor 202 may be configured to determine the first trajectory data based on the application of the set of geometric operations on the extracted second trip data and the determined first polygon 116. The first trajectory data may be associated with the first set of trajectories of the set of vehicles 104. Further, each trajectory of the first set of trajectories may be associated with the at least one portion (such as the first lane segment 114A of the road segment 112). Details about the first trajectory data are provided, for example, in FIG. 3.

The validation data determination module 202F of the processor 202 may be configured to determine validation data based on the first trajectory data. The validation data may be associated with the road closure event on the road segment 112. In an embodiment, the validation data may correspond to second road closure event data that is determined based on the first trajectory data. In an embodiment, the validation data may be associated with at least one of a first identifier associated with the road closure event, validation temporal information associated with the road closure event, a validation length of the at least one portion of the road segment 112 associated with the road closure event, a second identifier associated with the map for the road segment 112, a third identifier associated with the one or more sources 124, or a fourth identifier associated with the set of lane segments 114. Details about the validation data are provided, for example, in FIG. 3.

The validation module 202G of the processor 202 may be configured to validate the first road closure event data 118 based on a comparison of the first road closure event data 118 with the validation data. The result determination module 202H of the processor 202 may be configured to determine the first result based on the validation of the first road closure event data 118. The first result may be indicative of the occurrence of the road closure event in the at least one portion of the road segment 112.

The output module 202I of the processor 202 may be configured to output at least one of the determined first polygon 116, the extracted second trip data, the determined first trajectory data, the determined validation data, and the determined first result. In an embodiment, the output module 202I may be configured to generate one or more virtual objects indicating the determined first polygon 116, the extracted second trip data, the determined first trajectory data, the determined validation data, the determined first result, or a combination thereof. The output module 202I may be further configured to output the generated one or more virtual objects and the audio alerts on the I/O interface 206 of the system 102. In another embodiment, the output module 202I may be configured to transmit at least one of the extracted second trip data or the determined validation data to the database 106. In yet another embodiment, the output module 202I of the processor 202 may be configured to transmit the determined first result to the map database 108B.

The memory 204 of the system 102 may be configured to store the first road closure event data 118, the first trip data 120, and the map data 122. The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the system 102 to conduct various functions in accordance with an example of the present disclosure. For example, the memory 204 may be configured to buffer input data for processing by the processor 202. As exemplarily illustrated in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an ASIC, FPGA, or the like, the processor 202 may be specifically configured hardware for conducting the operations described herein.

In some examples, the I/O interface 206 may communicate with the system 102 and display the input and/or output of the system 102. As such, the I/O interface 206 may include a display and, in some embodiments, may also include a keyboard, a mouse, a joystick, a touch screen, touch areas, soft keys, one or more microphones, a plurality of speakers, or other input/output mechanisms. In one embodiment, the system 102 may include a user interface circuitry configured to control at least some functions of one or more I/O interface elements such as a display and, in some embodiments, a plurality of speakers, a ringer, one or more microphones and/or the like. The processor 202 and/or I/O interface 206 circuitry comprising the processor 202 may be configured to control one or more functions of one or more I/O interface 206 elements through computer program instructions (for example, software and/or firmware) stored on a memory 204 accessible to the processor 202. The processor 202 may further render notifications associated with the navigation instructions, such as traffic data, traffic conditions, traffic congestion value, ETA, routing information, road conditions, driving instructions, etc., on the user equipment or audio or display onboard the vehicles via the I/O interface 206.

The communication interface 208 may comprise an input interface and output interface for supporting communications to and from the system 102 or any other component with which the system 102 may communicate. The communication interface 208 may be any means such as a device or circuitry embodied in either hardware or a combination of hardware and software that is configured to receive and/or transmit data to/from a communications device in communication with the system 102. In this regard, the communication interface 208 may include, for example, an antenna (or multiple antennae) and supporting hardware and/or software for enabling communications with a wireless communication network. Additionally, or alternatively, the communication interface 208 may include the circuitry for interacting with the antenna(s) to cause transmission of signals via the antenna(s) or to manage receipt of signals received via the antenna(s). In some environments, the communication interface 208 may alternatively or additionally support wired communication. As such, for example, the communication interface 208 may include a communication modem and/or other hardware and/or software for supporting communication via cable, digital subscriber line (DSL), universal serial bus (USB), or other mechanisms. In some embodiments, the communication interface 208 may enable communication with a cloud-based network to enable deep learning, such as using the machine learning (ML) models (that may be hosted on the cloud-based network).

FIG. 3 is a block diagram 300 that illustrates an exemplary first set of operations for validation of road closure event on the road segment using trip data, in accordance with an embodiment of the disclosure. FIG. 3 is explained in conjunction with elements from FIG. 1 and FIG. 2. With reference to FIG. 3, there is shown the block diagram 300 that illustrates exemplary operations from 302 to 318, as described herein. The exemplary operations illustrated in the block diagram 300 may start at 302 and may be performed by any computing system, apparatus, or device, such as by the system 102 of FIG. 1 or the processor 202 of FIG. 2. Although illustrated with discrete blocks, the exemplary operations associated with one or more blocks of the block diagram 300 may be divided into additional blocks, combined into fewer blocks, or eliminated, depending on the particular implementation.

In an embodiment, the first road closure event data 118 may be utilized by the system 102 for the determination of the road closure event on the road segment 112. The exemplary operations from 302 to 318 may be executed as soon as a reception of the first road closure event data 118 from the one or more sources 124. In another embodiment, the exemplary operations from 302 to 318 may be executed based on a reception of a user input from a user associated with the validation of the road closure event on the road segment 112.

At 302, a data acquisition operation may be executed. In the data acquisition operation, the system 102 may be configured to obtain the first road closure event data 118. The first road closure event data 118 may be associated with the road closure event on the road segment 112. In an embodiment, the first road closure event data 118 may be associated with at least one of the first identifier associated with the road closure event, a length of the at least one portion of the road segment 112 associated with the road closure event, an incident status of the road closure event, temporal data associated with the road closure event, the second identifier associated with the map for the road segment 112, the third identifier associated with the one or more sources 124, an event type associated with the road closure event, a number of the set of lane segments 114 associated with the road closure event, a criticality score associated with the road segment 112, a user input associated with the road closure event, the fourth identifier associated with the set of lane segments 114, additional data associated with the road closure event or epoch data associated with the road closure event. Specifically, the input module 202A of the processor 202 may be configured to obtain the first road closure event data 118. In an embodiment, the system 102 may be configured to obtain the first road closure event from the database 106.

In an embodiment of the disclosure, the incident status is indicative of a status associated with the road closure event. For example, the incident status corresponds to at least one of a new status indicative of the occurrence of the road closure event at a starting time of the road closure event, a changed status associated with a change in the event type of the road closure event, or an expired status associated with an absence of the road closure event on the road segment 112. In an embodiment, the temporal information may include first temporal information associated with a starting time of the road closure event, second temporal information associated with an ending time of the road closure event, and third temporal information associated with the arrival time of each vehicle of the set of vehicles 104 in the at least one portion of the road segment 112. In an embodiment, the first temporal information may include a first timestamp that may indicate the starting time of the road closure event. Further, the second temporal information may include a second timestamp that may indicate the ending time of the road closure event. The third temporal information may include a third timestamp that may indicate the arrival time of each vehicle of the set of vehicles 104 in the at least one portion of the road segment 112. In an embodiment, the second identifier associated with the map for the road segment 112 may correspond to a version of the map. In an embodiment, the third identifier associated with the one or more sources 124 may correspond to a name associated with the one or more sources 124. In an embodiment, the criticality score associated with the road closure event may be indicative of a range for a total duration of the road closure event. In an embodiment, the total duration of the road closure event may correspond to a difference between the first temporal information associated with the starting time of the road closure event and the second temporal information associated with the ending time of the road closure event. In an embodiment, the additional data may include a binary value associated with the first road closure event data 118. The binary value may indicate whether there is a need to validate the first road closure event data 118 or not. In an embodiment, the epoch data may be indicative of a reference point in time from which the staring time of the road closure event is measured.

For example, the first identifier associated with the road closure event may be, but is not limited to, “4178173563586902937”, “4178173563586902937”, or “4178173563586902937”. For example, the length of the at least one portion of the road segment 112 may be, but is not limited to, “680. 18 meters”, “700 meters”, “875 meters”, or “950. 50 meters”. By way of an example and limitation, the first temporal information may correspond to “00:00:00”, “02:32:04”, or 02:32:04”. By way of an example and not limitation, the second temporal information may correspond to “02:34:18”, “04:34:24”, or “03:23:40”. By way of an example and not limitation, the third temporal information may correspond to “18:19:00”, “02:32:00”, or “47:04:21”. For example, the second identifier associated with the map for the road segment 112 may correspond to “201601”. By way of an example and not limitation, the name corresponds to the DOT, the ADAC, or the police department. By way of an example and not limitation, the event type corresponds to “ROAD_CLOSURE,” “ACCIDENT,” or “ROAD_MAINTAINENCE.” For example, the number of the set of lane segments 114 associated with the road closure event may be, but is not limited to, “0”, “1”, “2”, or “4”. For example, the event criticality score may correspond to “2” that may indicate the total duration of the road closure event is between in a range of “2 hours to 4 hours”. For example, the first temporal information may correspond to “18:00:00” and the second temporal information may correspond to “20:00:00”. Further, the total duration of the road closure event may correspond to 2 hours based on a difference between “20:00:00” and “18:00:00”. By way of an example and not imitation, the user input corresponds to “A37”. For example, the fourth identifier associated with the set of lane segments 114 corresponds to “997263402”. By way of an example and not limitation, the reference point in time may correspond to “1.46118E+12”. For example, the binary value may correspond to 0 which may indicate that there is no need to validate the first road closure event data 118. In another example, the binary value may correspond to “1” which may be indicative of a need to validate the first road closure event data 118.

Based on the first road closure event data 118, the system 102 may be configured to obtain the first trip data 120 associated with the first set of trips taken by the set of vehicles 104 traveling on the road segment 112. Further, each trip of the first set of trips may be associated with the road segment 112. Specifically, the input module 202A of the processor 202 may be configured to obtain the first trip data 120 based on the first road closure event data 118. In an embodiment, the first trip data 120 may include, but is not limited to, the start time for each trip of the first set of trips, the end time for each trip of the first set of trips, the first set of coordinates for each trip of the first set of trips, the first temporal data associated with each trip of the first set of trips, the speed of each vehicle of the set of vehicles 104 on each trip of the first set of trips, or contextual data associated with a context of each trip of the first set of trips (such as a shopping trip, a doctor appointment trip, a working commute trip, or a socializing event trip associated with each trip of the first set of trips).

In an embodiment, the first set of coordinates may include at least a first coordinate associated with a starting point of each trip of the first set of trips and a second coordinate associated with an ending point of each point of the first set of trips. In another embodiment, the first set of coordinates may be associated with a first set of stopover points for the users of the set of vehicles 104. Further, the first set of stopover points may be associated with each trip of the first set of trips. In an embodiment, the first set of stopover points may be associated with traffic on the road segment 112, or a first set of points of interest (such as the shopping mall, the parks, and the like) on the road segment 112. In an embodiment, the first temporal data may be indicative of a start time for each trip of the first set of trips. Further, the first temporal data may be indicative of an end time for each trip of the first set of trips. For example, a first start time for a first trip of the first set of trips may be, but is not limited to, “02:32:00”. For example, a first end time for the first trip of the first set of trips may be, but is not limited to, “04:32:00”. In an embodiment, each coordinate of the first set of coordinates may be indicative of the location of the corresponding vehicle of the set of vehicles 104 on the road segment 112.

For example, the speed of each vehicle of the set of vehicles 104 on each trip of the first set of trips may be, but is not limited to, 10 miles per hour (mph), 20 mph, or 25 mph. In an embodiment, the contextual data may include a set of origin-destination (OD) pairs associated with the context of each trip of the first set of trips. The set of OD pairs may include, but are not limited to, a Home to Work (H2W) pair, a Work to Home (W2H) pair, a Work to Other (W2O) pair, an Other to Work (O2W) pair, a Home to Other (H2O) pair, an Other to Home (O2H) pair, an Other to other (O2O), a Home based Other (HBO) pair, a Home based Work (HBW) pair, or a Non-home based pair (NHB). The H2W pair may be indicative of a trip of a user from a home location to a work location. For example, the user is associated with the first vehicle 104A of the set of vehicles 104. The W2H pair may be indicative of a trip of the user from the work location to the home location. The W2O pair may be indicative of a trip from the work location to another location (such as a shopping mall, a park, a railway station, and the like). The O2W pair may be indicative of a trip of the user from the other location to the work location. The H2O pair may be indicative of a trip of the user from the home location to the other location. The O2O trip may be indicative of a trip of the users from a first other location to a second location. The HBO may be indicative of the first one or more OD pairs associated with the home location and the other location (such as the H2O pair or the O2H pair). The HBW may be indicative of a second one or more OD pairs associated with the home location and the work location (such as the H2W pair, or the W2H trip), The NHB may be indicative of a third one or more OD pairs associated with non-home based trips (such as the O2W pair, the W2O pair, or the O2O pair).

In another embodiment, the system 102 may be configured to obtain the map data 122. The map data 122 may be associated with the road segment 112. Specifically, the input module 202A of the processor 202 may be configured to obtain the map data 122 associated with the road segment 112. For the sake of explanation, the road segment 112 may include any route between two locations that allows travel by foot, the set of vehicles 104, or any other form of travel. Examples of the road segment 112 may include, but are not limited to, streets, highways, freeways, trails, bridges, tunnels, toll roads, and/or crossings. In an embodiment, the road segment 112 may connect with another road segment at an intersection. The intersection may correspond to a section of the road segment 112 that allows users associated with the set of vehicles 104 to travel from the road segment 112 to another road segment.

In an embodiment, the map data 122 may be associated with the set of maps of the road segment 112. In an embodiment, the map data 122 may be associated with the geometry of the road segment 112 (such as the length of the road segment 112, the locations of intersections on the road segment 112, and the like), speed limits for the set of vehicles 104, a road directionality of the road segment 112 (such as a one-way directionality, or a two-way directionality), and a type of the road segment 112 (such as a street, a residential, a highway, or a toll).

At 304, a polygon determination operation may be executed. In the polygon determination operation, the system 102 may be configured to determine the first polygon 116 to encompass the at least one portion of the road segment 112 based on the first road closure event data 118 and the map data 122. Specifically, the polygon determination module 202B of the processor 202 may be configured to determine the first polygon 116 to encompass the at least one portion of the road segment 112 based on the first road closure event data 118 and the map data 122. In an embodiment, the first polygon 116 may correspond to the closed two-dimensional shape that includes the set of line segments connected end-to-end to form the closed chain. Details about the first polygon 116 are provided, for example, in FIG. 1. In an embodiment, the system 102 may be configured to determine the first polygon 116 to map the road closure event on the at least one portion of the road segment 112. For example, the system 102 may be configured to map an area associated with the road closure event based on the length of the road segment 112 and the length of the at least one portion of the road segment 112 associated with the road closure event.

In an embodiment, the system 102 may be further configured to determine the second trip data for the at least a portion of the road segment 112 encompassed by the first polygon 116. In an embodiment, the system 102 may be configured to extract the second trip data for each trip of the first set of trips that is taken by the set of vehicles 104 on the at least one portion of the road segment 112. In another embodiment, the system 102 may be configured to increase a resolution associated with the first polygon 116 based on the HD map data and the first road closure event data. The increase in the resolution may further increase the accuracy associated with the extraction of the second trip data from the first trip data 120 as discussed at 306.

At 306, a trip data extraction operation may be executed. In the trip data extraction operation, the system 102 may be configured to extract the second trip data from the first trip data 120. The first set of trips may be taken by the set of vehicles 104 traveling on the road segment 112. In an embodiment, the second trip data may correspond to the subset of the first trip data 120. The second trip data may be associated with a second set of trips. Further, each trip of the second set of trips may be associated with the at least one portion of the road segment 112. In an embodiment, each trip of the second set of trips is taken by the set of vehicles 104 traveling on the at least one portion of the road segment 112. Specifically, the trip data extraction module 202C of the processor 202 may be configured to extract the second trip data from the first trip data 120. In an embodiment, the second trip data may include, but is not limited to, the start time for each trip of a second set of trips, the end time for each trip of the first set of trips, the second set of coordinates for each trip of the second set of trips, and a speed of each vehicle of the set of vehicles 104 on each trip of the second set of trips. For example, the start time for the second trip of the second set of trips may be but is not limited to, “02:32:00”. For example, the end time for the second trip of the second set of trips may be, but is not limited to, “04:32:00”. In an embodiment, each coordinate of the second set of coordinates may be indicative of the location of the corresponding vehicle of the set of vehicles 104 on the at least one portion of the road segment 112. In an embodiment, the second set of coordinates may include a first coordinate associated with a starting point of each trip of the second set of trips and a second coordinate associated with an ending point of each trip of the second set of trips. In another embodiment, the second set of coordinates may be associated with a second set of stopover points for the users of the set of vehicles 104. Further, the second set of stopover points may be associated with the at least one portion of the road segment 112. In an embodiment, the second set of stopover points may be associated with traffic on the at least one portion of the road segment 112, or a second set of points of interest (such as the shopping mall, the parks, and the like) on the at least one portion of the road segment 112. For example, the speed of each vehicle of the set of vehicles 104 on each trip of the second set of trips may be, but is not limited to, 10 mph, 20 mph, or 25 mph.

At 308, geometric operations application may be executed. In the geometric operations application, the system 102 may be configured to apply the set of geometric operations on the extracted second trip data and the determined first polygon 116. Specifically, the geometric operations application module 202D of the processor 202 may be configured to apply the set of geometric operations on the extracted second trip data and the determined first polygon 116. In an embodiment, the set of geometric operations may include at least one of the polygon geometry overlay operations, the spatial join operation, or the intersection operation. In an embodiment, the system 102 may be configured to determine the first trajectory data based on the application of the set of geometric operations on the extracted second trip data and the determined first polygon 116. Details about the application of the set of geometric operations are provided, for example, in FIG. 2.

At 310, a trajectory data determination operation may be executed. In the trajectory data determination operation, the system 102 may be configured to determine the first trajectory data based on the application of the set of geometric operations on the extracted second trip data and the determined first polygon 116. The first trajectory data may be associated with the first set of trajectories of the set of vehicles 104. Each trajectory of the first set of trajectories may be associated with the at least one portion of the road segment 112. Specifically, the trajectory data determination module 202E of the processor 202 may be configured to determine the first trajectory data based on the application of the set of geometric operations on the extracted second trip data and the determined first polygon 116. The first trajectory data may include at least one of the count of trajectories in the first set of trajectories, the location of each vehicle of the set of vehicles 104 in the at least one portion of the road segment, the temporal data associated with each trajectory of the first set of trajectories, or the speed of each vehicle of the set of vehicles 104 on the at least one portion of the road segment.

For example, the count of trajectories in the first set of trajectories may be, but is not limited to, “0”, “2”, “3”, or “5”. In an embodiment, the temporal data may be indicative of the starting time associated with the start point of each trajectory of the first set of trajectories. Further, the temporal data may be indicative of the ending time associated with the end point of each trajectory of the first set of trajectories. For example, a first starting time associated with a first trajectory may correspond to “02:32:00”. In another example, a first ending time associated with the first trajectory may correspond to “04:35:34”. For example, the speed of each vehicle of the set of vehicles 104 on the least one portion of the road segment 112 may be, but is not limited to, 0 mph, 10 mph 20 mph, or 30 mph.

At 312, a validation data determination operation may be executed. In the validation data determination operation, the system 102 may be configured to determine the validation data based on the first trajectory data. The validation data may be associated with the road closure event on the road segment 112. Specifically, the validation data determination module 202F of the processor 202 may be configured to determine the validation data based on the first trajectory data. In an embodiment, the validation data may correspond to second road closure event data that is determined based on the first trajectory data. In an embodiment, the validation data may be associated with at least one of the first identifier associated with the road closure event, the validation length of the at least one portion of the road segment 112 associated with the road closure event, the validation temporal information associated with the road closure event, the second identifier associated with the map for the road segment 112, the third identifier associated with the one or more sources 124, or the fourth identifier associated with the set of lane segments 114.

In an embodiment, the validation temporal information may include first validation temporal information associated with the starting time of the road closure event and second validation temporal information associated with the ending time of the road closure event. In another embodiment, the validation temporal information may further include a validation total duration of the road closure event. In an embodiment, the validation total duration of the road closure event may correspond to a difference between the first validation temporal information and the second validation temporal information. For example, the first validation temporal information associated with the starting time of the road closure event and the second validation temporal information associated with the ending time of the road closure event may correspond to “18:00:00” and “20:00:00”, respectively. Further, the validation total duration of the road closure event may correspond to 2 hours based on a difference between “20:00:00” and “18:00:00”. In an embodiment, the system 102 may be configured to determine the first validation temporal information based on the starting time of each trajectory of the first set of trajectories. In another embodiment, the system 102 may be configured to determine the second validation information based on an ending time of each trajectory of the second set of trajectories.

In yet another embodiment, the system 102 may be configured to determine validation length of the at least one portion of the road segment 112 based on the location of the start point of each trajectory of the first set of trajectories and the end point of each trajectory of the first set of trajectories. In an embodiment, the system 102 may be configured to determine a second difference between the start point of each trajectory of the first set of trajectories and the end point of each trajectory of the first set of trajectories. Further, the system 102 may be configured to determine the validation length of the at least one portion of the road segment 112 based on the second difference between the start point of each trajectory of the first set of trajectories and the end point of each trajectory of the first set of trajectories.

At 314, a data validation operation may be executed. In the data validation operation, the system 102 may be configured to validate the first road closure event data 118 based on a comparison of the first road closure event data 118 with the validation data. Specifically, the validation module 202G of the processor 202 may be configured to validate the first road closure event data 118 based on a comparison of the first road closure event data 118 with the validation data.

In an embodiment, the system 102 may be configured to determine a first duration based on a difference between the first temporal information associated with the starting time of the road closure event and the first validation temporal information associated with the starting time of the road closure event. Further, the system 102 may be configured to compare the first duration with a first time threshold (such as 5 minutes, 10 minutes, or 12 minutes). In an embodiment, the system 102 may be configured to determine the first road closure event data 118 is accurate based on a determination that the first duration is less than the first time threshold. In another embodiment, the system 102 may be configured to determine that first road closure event data 118 is inaccurate based on a determination that the first duration is greater than the first time threshold.

In an embodiment, the system 102 may be configured to determine a second duration based on a difference between the second temporal information associated with the ending time of the road closure event and the second validation temporal information associated with the starting time of the road closure event. Further, the system 102 may be configured to compare the second duration with the first time threshold (such as 5 minutes, 10 minutes, or 12 minutes). In an embodiment, the system 102 may be configured to determine the first road closure event data 118 is accurate based on a determination that the second duration is less than the first time threshold. In another embodiment, the system 102 may be configured to determine that first road closure event data 118 is inaccurate based on a determination that the second duration is greater than the first time threshold.

In an embodiment, the data validation operation may decrease a computational complexity associated with the validation of the road closure event for each portion of the road segment 112. Additionally, the decrease in the computational complexity may further lead to a decrease in computational cost associated with the validation of the road closure event for each portion of the road segment 112.

At 316, a result determination operation may be executed. In the result determination operation, the system 102 may be configured to determine the first result based on the validation of the first road closure event data 118. The first result may be indicative of the occurrence of the road closure event on the road segment. Specifically, the result determination module 202H of the processor 202 may be configured to determine the first result based on the validation of the first road closure event data 118. In an embodiment, the first result may be indicative of the presence of the road closure event on the road segment 112. In another embodiment, the first result may be indicative of an absence of the road closure event on the road segment 112. In an embodiment, the first result may correspond to a set of numerical values to indicate the occurrence of the road closure event on the road segment 112. For example, the first result corresponds to 1 which may indicate the presence of the road closure event on the road segment 112. In another example, the first result corresponds to 0 which may indicate the absence of the road closure event on the road segment 112.

At 318, a result output operation may be executed. In the result output operation, the system 102 may be configured to output the first result. Specifically, the output module 202I of the processor 202 may be configured to output the first result. In an embodiment, the output of the determined first result may correspond to a rendering of the first result on a user interface associated with the system 102. In another embodiment, the system 102 may be configured to determine the occurrence of the road closure event based on the validation of the first road closure event data 118. In yet another embodiment, the system 102 may be configured to render the first polygon 116 on the user device associated with the system 102 to indicate the occurrence of the road closure event. In an embodiment, the system 102 may output the validated first road closure event data to various navigation applications based on the first result. Various navigation applications (such as web-based applications, mobile-based applications, and the like) or navigation systems (such as road closure warning systems) may assist (such as directions for driving) the users of the set of vehicles 104 based on the validated first road closure event data. Additionally, various navigation applications and the navigation system may increase based on the utilization of the validated road closure event data.

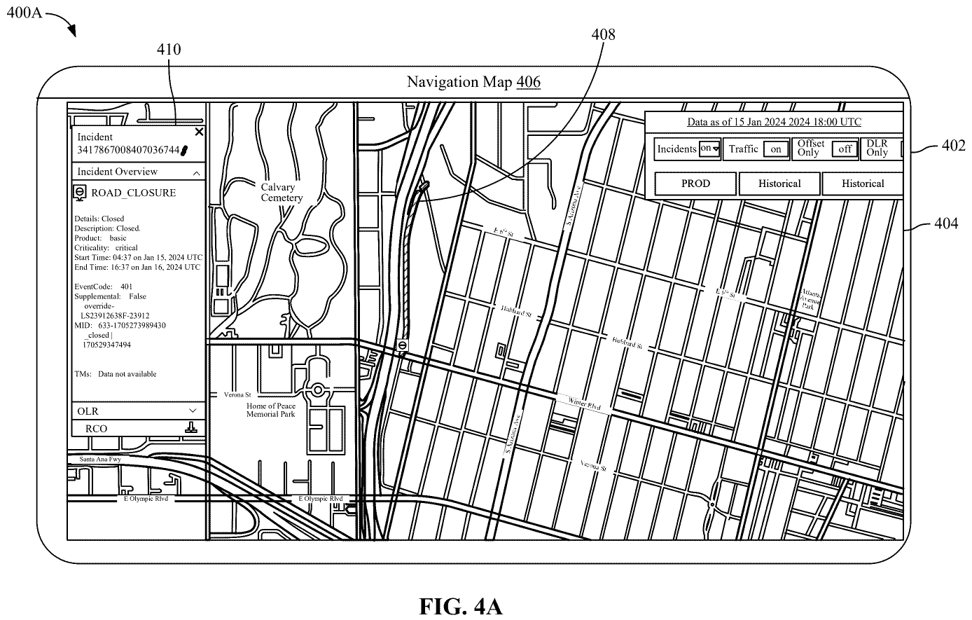

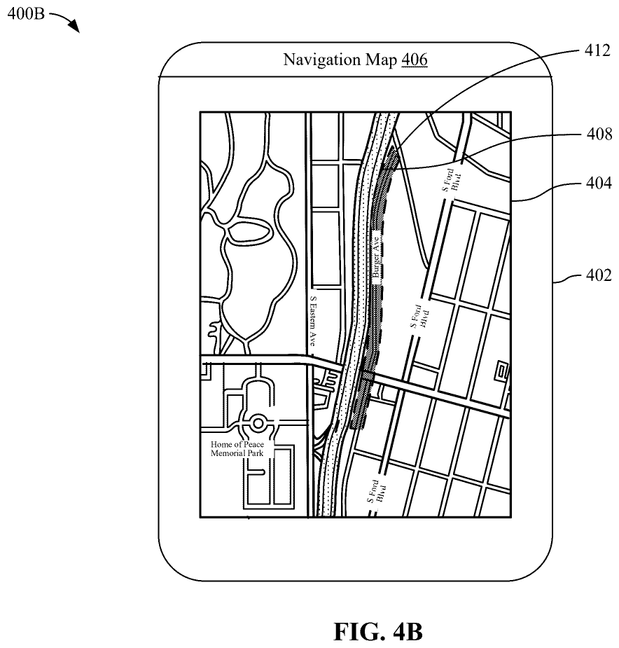

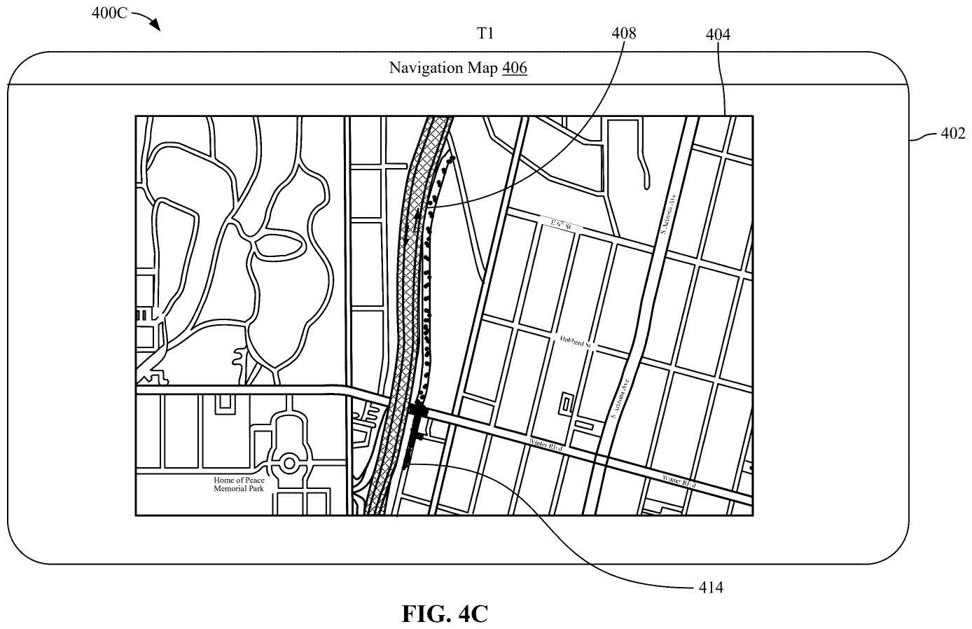

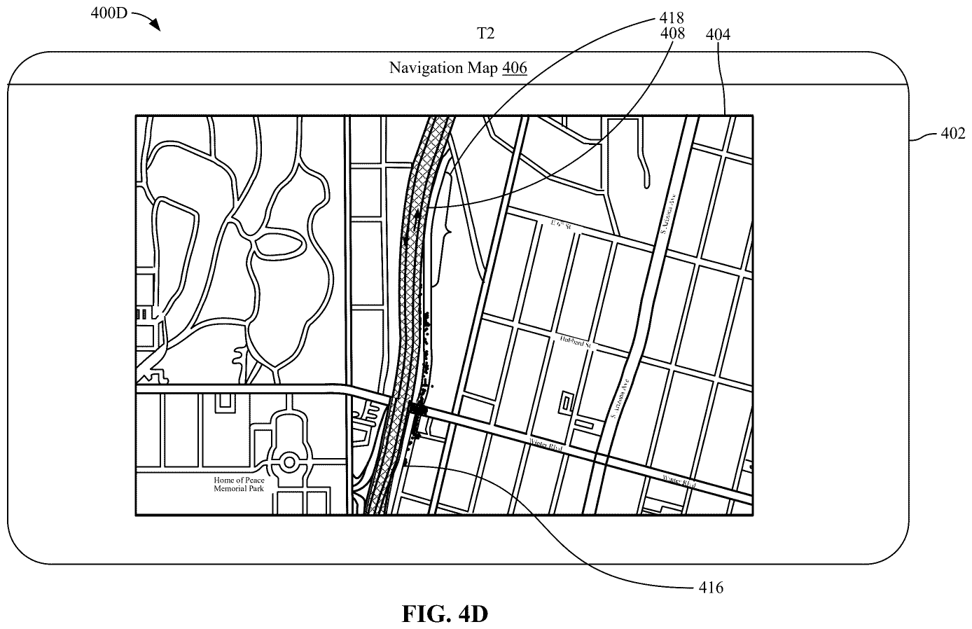

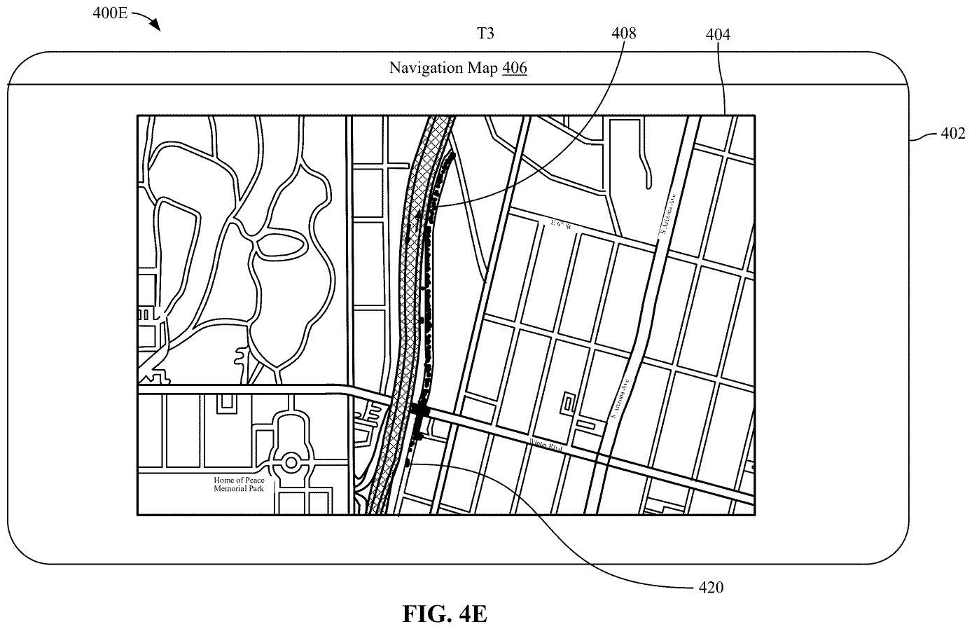

In an embodiment, the system 102 may be configured to a first confidence score associated with the first result. The first confidence score may be indicative of the likelihood that the first result is correct. In an embodiment, the system 102 may be configured to determine the first confidence score based on trajectory data (such as a set of trajectory points) for a plurality of time periods. Accordingly, diagrams are provided with reference to FIG. 4A, FIG. 4B, FIG. 4C, FIG. 4D, and FIG. 4E.

FIG. 4A is a diagram 400 that depicts an exemplary first user interface associated with the operations for validation of the road closure event on the road segment, in accordance with an embodiment of the disclosure. FIG. 4A is explained in conjunction with FIG. 1, FIG. 2, and FIG. 3. With reference to FIG. 4A, there is shown an electronic device 402 associated with the system 102. The electronic device 402 may include a user interface 404 that may be configured to render a navigation map 406 of a geographical region. The geographical region may include a road segment 408.

In an embodiment, the system 102 may be configured to validate road closure event data 410 based on a reception of the road closure event data 410 from the one or more sources 124. The road closure event data 410 may be associated with the road closure event on the road segment 408. In an embodiment, the system 102 may be configured to obtain the road closure event data 410 from the database 106.

In an embodiment, the electronic device 402 may further render the road closure event data 410 on the user interface 404. In an embodiment, the road closure event data 410 may be referred to as “incident overview data”. The road closure event data 410 may include at least one of a detail associated with the road closure event, a description associated with the road closure event, a product (such as a road closure warning system) associated with the road closure event, a criticality level associated with the road closure event, a start time associated with the road closure event on the road segment 408, an end time associated with the road closure event on the road segment 408, an event code associated with the road closure event, supplemental data associated with the road closure event, a map identifier (MID) associated with the road closure event, and traffic message channels (TMCs) associated with the road closure event.

In an embodiment, the detail associated with the road closure event may be indicative of the current status (such as a closed status or an open status) of the road closure. In an embodiment, the closed status may be indicative of an absence of the road closure event on the road segment 408. In another embodiment, the open status may be indicative of the presence of the road closure event on the road segment 408. In an embodiment, the description associated with the road closure event may be indicative of a description of the current status of the road closure event. In an embodiment, the criticality level associated with the road closure event may be indicative of a range for the total duration of the road closure event on the road segment 408. In an embodiment, the event code associated with the road closure event may correspond to an identifier associated with the road closure event. In an embodiment, the supplementary data may be indicative of additional data associated with the road closure event on the road segment 408. In an embodiment, the supplementary data may be indicative of at least an identifier associated with the additional data.

By way of an example and not limitation, the description of the current status may correspond to “Closed” which may indicate the closed status of the road closure event. In an embodiment, the road closure event data 410 may be indicative of a version (such as a basic version, a premium version, and the like) of the product. By way of an example and not limitation, the criticality level associated with the road closure event corresponds to “critical” which may indicate that the total duration of the road closure event is between “2 hours to 4 hours”. By way of another example and not limitation, the criticality level associated with the road course event corresponds to “non-critical” which may indicate the total duration of the road closure event is between “1 hour to 2 hours” By way of an example and not limitation, the start time associated with the road closure event may be “04:37 on Jan. 15, 2024, UTC”. By way of an example and not limitation, the end time associated with the road closure event may be “16:37 on Jan. 16, 2024, UTC”. For example, the event code associated with the road closure event may be ‘401’. The supplemental data associated with the road closure event may correspond to ‘False override-LS23912638F-23912’. For example, the MID associated with the road closure event may be ‘633-1705273989430_closed|1705293474394’. For example, the road closure event data 410 may indicate whether the road closure event data 410 is received from the TMCs or not. For example, the road closure event data 410 may include a text (such as Data not available) that may indicate that the road closure event data 410 is not collected from the TMCs.

FIG. 4B is a diagram 400B that depicts an exemplary second user interface associated with the operations for validation of the road closure event on the road segment, in accordance with an embodiment of the disclosure. FIG. 4B is explained in conjunction with FIG. 1, FIG. 2, FIG. 3 and FIG. 4A. With reference to FIG. 4B, the system 102 may be further configured to render an enlarged view of the navigation map 406 based on the reception of the road closure event data 410. In an embodiment, the system 102 may be configured to determine a first polygon 412 based on the road closure event data 410 and map data 122 associated with the road segment 408. In an embodiment, the system 102 may be configured to determine the first polygon 412 to encompass at least one portion of the road segment 408.

In an embodiment, the system 102 may be configured to obtain the map data 122. The map data 122 may be associated with the road segment 408. In an embodiment, the map data 122 may be associated with the navigation map 406. In an embodiment, the map data 122 may be associated with the geometry of the road segment 408 (such as a length of the road segment 408, locations of intersections on the road segment 408, and the like), speed limits for the set of vehicles 104 on the road segment 408, a road directionality of the road segment 408 (such as a one-way directionality, or a two-way directionality) , and a type of the road segment 408 (such as a street, a residential, a highway, or a toll).

In an embodiment, the system 102 may be configured to determine the first polygon 412 to map the road closure event on the at least one portion of the road segment 408. For example, the system 102 may be configured to map an area associated with the road closure event based on the length of the road segment 408 and the length of the at least one portion of the road segment 408 associated with the road closure event.

FIG. 4C is a diagram 400C that depicts an exemplary third user interface associated with the operations for validation of the road closure event on the road segment, in accordance with an embodiment of the disclosure. FIG. 4C is explained in conjunction with FIG. 1, FIG. 2, FIG. 3, FIG. 4A and FIG. 4B. With reference to FIG. 4C, the system 102 may be configured to determine a first set of trajectory points 414 for a first time period “T1”. For example, the first time period corresponds to a day before the starting day of the road closure event on the road segment 408. In an embodiment, the first time period “T1” may correspond to “2024 Jan. 14”. Further, each of the first set of trajectory points 414 may be associated with the road segment 408. In an embodiment, each trajectory point of the first set of trajectory points 414 may be indicative of at least a first location of the corresponding vehicle of the set of vehicles 104 on the road segment 408.

In an embodiment, the system 102 may be configured to determine the first set of trajectory points 414 based on points of interest (POIs) data for the first time period. The POIs data may be associated with one or more points of interest (such as streetlights, buildings, or towers) associated with the road segment 408. In an embodiment, the system 102 may be configured to obtain the POI data based on the determined first polygon 412. In an embodiment, the POIs data may include at least a set of identifiers for each of the one or more POIs. By way of an example and not limitation, the set of identifiers for the one or more POIs may correspond to ‘34.029107’, ‘−118.171345’, ‘34.028280’, ‘−118.171764’, ‘34.027337’, ‘−118.172000’, ‘34.024270’, ‘−118.172096’, ‘34.022296’, ‘−118.172654’, ‘34.022251’, ‘−118.172289’, ‘34.024181’, ‘−118.171656’, ‘34.027160’, ‘−118.171667’, ‘34.028849’, ‘−118.171163’, ‘34.028902’, or ‘−118.171141’.

FIG. 4D is a diagram 400D that depicts an exemplary fourth user interface associated with the operations for validation of the road closure event on the road segment, in accordance with an embodiment of the disclosure. FIG. 4D is explained in conjunction with FIG. 1, FIG. 2, FIG. 3, FIG. 4A, FIG. 4B, and FIG. 4C. With reference to FIG. 4D, the system 102 may be configured to determine a second set of trajectory points 416 for a second time period “T2”. For example, the second time period corresponds to the starting day of the road closure event on the road segment 408. In an embodiment, the starting day corresponds to “2024 Jan. 15”. Further, each of the second set of trajectory points 416 may be associated with the road segment 408. In an embodiment, each trajectory point of the second set of trajectory points 416 may be indicative of at least a second location of the corresponding vehicle of the set of vehicles 104 on the road segment 408. The second location of the corresponding vehicle of the set of vehicles 104 may be associated with the second time period “T2”. In an embodiment, the system 102 may be configured to determine the second set of trajectory points 416 based on POI data for the second time period. Details about the POIs data are provided, for example, in FIG. 4C.

In an embodiment, the system 102 may be configured to determine an absence of the second set of trajectory points 416 in at least one portion 418 of the road segment 408 for the second time period “T2”. In an embodiment, the system 102 may be configured to determine the absence of the second set of trajectory points 416 in the at least one portion 418 of the road segment 408 based on the POIs data for the second time period “T2”. In an embodiment, the system 102 may be configured to determine the presence of the road closure event on the road segment 112 based on a determination that the second set of trajectory points 416 is absent in the at least one portion 418 of the road segment 408.

FIG. 4E is a diagram 400E that depicts an exemplary fifth user interface associated with the operations for validation of the road closure event on the road segment, in accordance with an embodiment of the disclosure. FIG. 4E is explained in conjunction with FIG. 1, FIG. 2, FIG. 3, FIG. 4A, FIG. 4B, FIG. 4C, and FIG. 4D. With reference to FIG. 4E, the system 102 may be configured to determine a third set of trajectory points 420 for a third time period “T3”. For example, the third time period corresponds to a day after the starting day of the road closure event on the road segment 408. In an embodiment, the third time period may correspond to “2024 Jan. 16”. Further, each of the third set of trajectory points 420 may be associated with the road segment 408. In an embodiment, each trajectory point of the third set of trajectory points 420 may be indicative of at least a third location of the corresponding vehicle of the set of vehicles 104 on the road segment 408. The third location of the corresponding vehicle of the set of vehicles 104 may be associated with the third time period “T3”. In an embodiment, the system 102 may be configured to determine the third set of trajectory points 420 based on POI data for the third time period. Details about the POIs data are provided, for example, in FIG. 4C.

In an embodiment, the system 102 may be configured to determine a first number of trajectory points of the first set of trajectory points 414 for the first time period “T1”. The system 102 may be configured to determine a second number of trajectory points of the second set of trajectory points 416 for the second time period “T2”. Further, the system 102 may be configured to determine a third number of trajectory points of the third set of trajectory points 420 for the third time period “T3”. In an embodiment, the system 102 may be configured to determine a second confidence score based on a comparison of the first number of trajectory points of the first set of trajectory points 414 and the second number of trajectory points of the second set of trajectory points 416. Further, the system 102 may be configured to determine a third confidence score based on a comparison of the first number of trajectory points of the first set of trajectory points 414 and the third number of trajectory points of the third set of trajectory points 420. In an embodiment, the system 102 may be configured to determine the first confidence score based on the second confidence score and the third confidence score. The first confidence score may be indicative of the likelihood that the first result is correct. In an embodiment, the system 102 may be configured to output the first result based on a comparison of the first confidence score with a predefined confidence score. In an embodiment, the system 102 may be configured to output the first result based on a determination that the first confidence score is greater than the predefined confidence score. Details about the output of the first result are provided, for example, in FIG. 3. In another embodiment, the system 102 may be configured to determine that that first result is incorrect based on a determination that the first confidence score is less than the predefined confidence score.

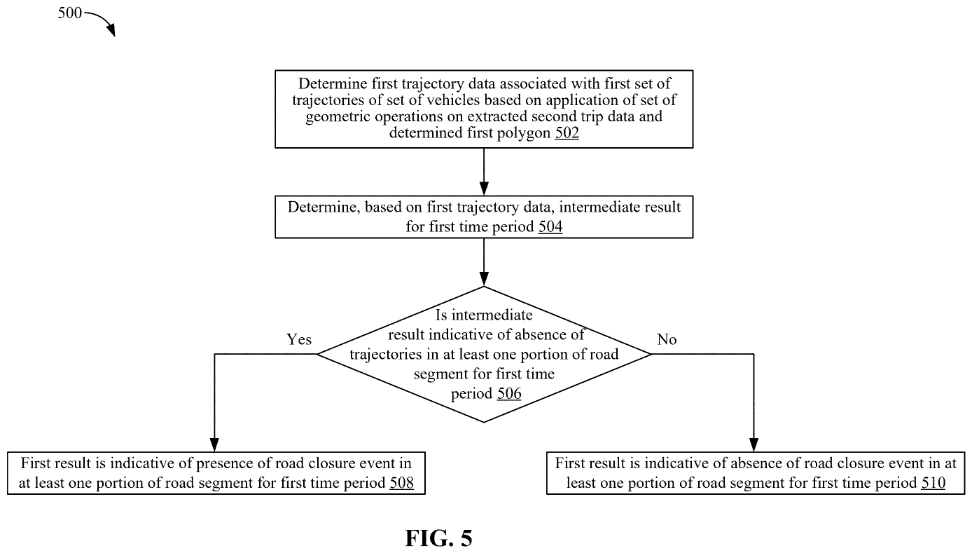

FIG. 5 is a block diagram 500 that illustrates an exemplary second set of operations for validation of the road closure events on the road segment based on the trip data, in accordance with an embodiment of the disclosure. FIG. 5 is explained in conjunction with elements from FIG. 1, FIG. 2, FIG. 3, FIG. 4A, FIG. 4B, FIG. 4C, FIG. 4D and FIG. 4E. With reference to FIG. 5, there is shown the block diagram 500 that illustrates exemplary operations from 502 to 510, as described herein. The exemplary operations illustrated in the block diagram 500 may be performed by any computing system, apparatus, or device, such as by the system 102 of FIG. 1 or the processor 202 of FIG. 2. Although illustrated with discrete blocks, the exemplary operations associated with one or more blocks of the block diagram 500 may be divided into additional blocks, combined into fewer blocks, or eliminated, depending on the particular implementation.

At 502, the first trajectory data associated with the first set of trajectories of the set of vehicles 104 may be determined. In an embodiment, the system 102 may be configured to determine the first trajectory data associated with the first set of trajectories of the set of vehicles 104 based on the application of the set of geometric operations on the extracted second trip data and the determined first polygon 116. Details about the application of the set of geometric operations are provided, for example, in FIG. 2.

The first trajectory data may include at least one of a count of trajectories in the first set of trajectories, a location of each vehicle of the set of vehicles 104 in the at least one portion of the road segment 112, temporal data associated with each trajectory of the first set of trajectories, or a speed of each vehicle of the set of vehicles 104 on the at least one portion of the road segment 112.

For example, the count of trajectories in the first set of trajectories may be, but is not limited to, 0, 2, 3, or 5. In an embodiment, the location of each vehicle of the set of vehicles 104 may correspond to a set of coordinates on the at least one portion of the road segment 112. In an embodiment, the temporal data associated with each trajectory of the first set of trajectories is indicative of timestamps associated with each location of the set of vehicles 104 in the at least one portion of the road segment 112. For example, the speed of each vehicle of the set of vehicles 104 on the least one portion of the road segment 112 may be, but is not limited to, 0 mph, 10 mph 20 mph, or 30 mph.

At 504, an intermediate result for a first time period may be determined based on the first trajectory data. The first time period is associated with an occurrence of the road closure event on the at least one portion of the road segment 112. In an embodiment, the system 102 may be configured to determine the intermediate result for the first time period based on the first trajectory data. The intermediate result is indicative of an occurrence of the trajectories in the at least one portion of the road segment 112 for a first time period.

At 506, a determination is made whether the intermediate result is indicative of an absence of the trajectories in the at least one portion of the road segment 112 for the first time period or not. In an embodiment, the system 102 may be configured to determine the first result based on the determination that the intermediate result is indicative of the absence of the trajectories in the at least one portion 418 of the road segment 408 for the first time period. The first result may be indicative of the presence of the road closure event in the at least one portion of the road segment 112 for the first time period.

In an embodiment, the intermediate result is indicative of the absence of the trajectories based on a determination that the count of the trajectories of the first set of trajectories is 0. In another embodiment, the intermediate result is indicative of the absence of the trajectories based on a determination that the speed of the set of vehicles 104 on the at least one portion of the road segment 112 is 0 K/hr. In yet another embodiment, the intermediate result is indicative of the absence of the trajectories based on a determination that the speed of the set of vehicles 104 on the at least one portion of the road segment 112 is less than a speed threshold (such as 10 mph).

At 508, a first percentage indicative of an area associated with the at least one portion of the road segment 112 may be determined. In an embodiment, the system 102 may be configured to determine the first percentage to indicate the size of the area associated with the road closure event. In an embodiment, the system 102 may be configured to determine the first percentage based on the determination that the first result is indicative of the presence of the road closure event in the at least one portion of the road segment 112 for the first time period. The first percentage may be indicative of the area associated with the at least one portion of the road segment 112. In another embodiment, the system 102 may be configured to determine the first percentage based on the first trajectory data. In an embodiment, the system 102 may be configured to determine the first percentage based on the count of trajectories of the first set of trajectories. For example, the first percentage may correspond to 100 percent based on a determination that the count of trajectories is 0 on the at least one portion of the road segment 112 for the first time period. In another example, the first percentage may correspond to 50 percentage based on a determination that the count of trajectories is 0 on a half of the at least one portion of the road segment 112 or the first time period. In an additional example, the road segment 112 may include three lane segments, the first lane segment 114A, the second lane segment 114B, and the Nth lane segment 114N. Further, the first percentage may correspond to 33.33 percentage based on a determination that the count of trajectories on the first lane segment 114A is 0.

At 510, the first result indicative of an absence of the road closure event in the at least one portion of the road segment for the first time period may be determined. In an embodiment, the system 102 may be configured to determine the first result indicative of the absence of the road segment based on a determination that the intermediate result is indicative of the presence of the trajectories in the at least one portion of the road segment 112 for the first time period may be performed. In an embodiment, the system 102 may be configured to determine the first result based on the determination if the intermediate result is indicative of the presence of the trajectories in the at least one portion of the road segment 112 for the first time period. The first result may be indicative of an absence of the road closure event in the at least one portion of the road segment 112 for the first time period.

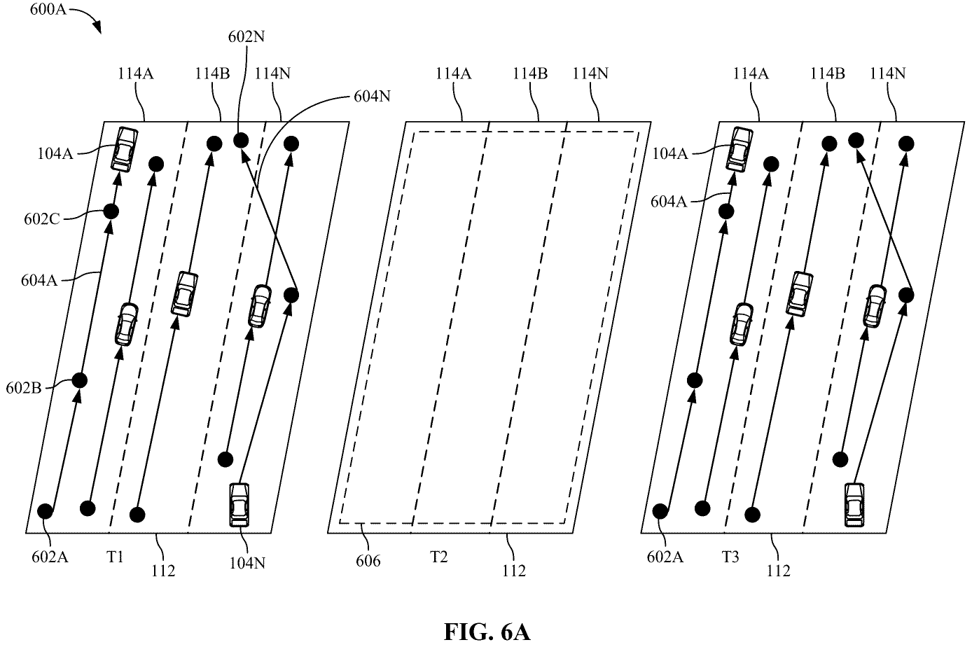

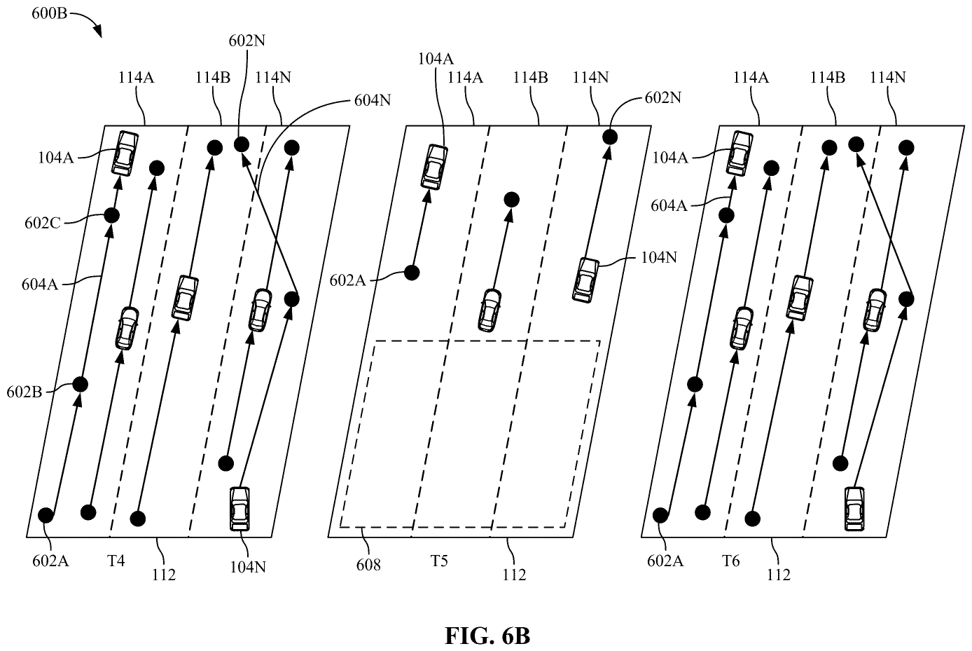

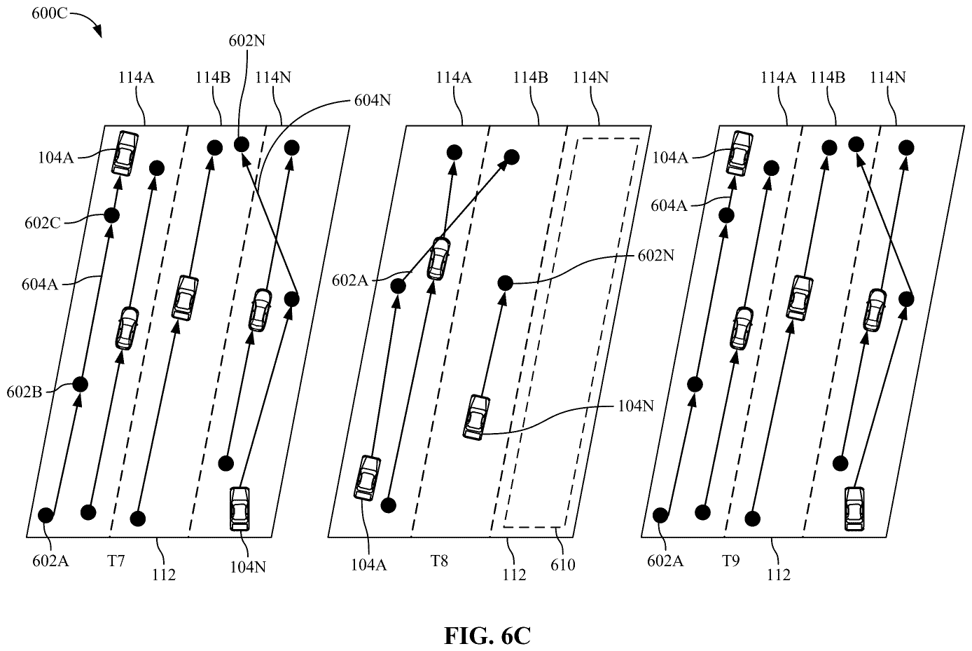

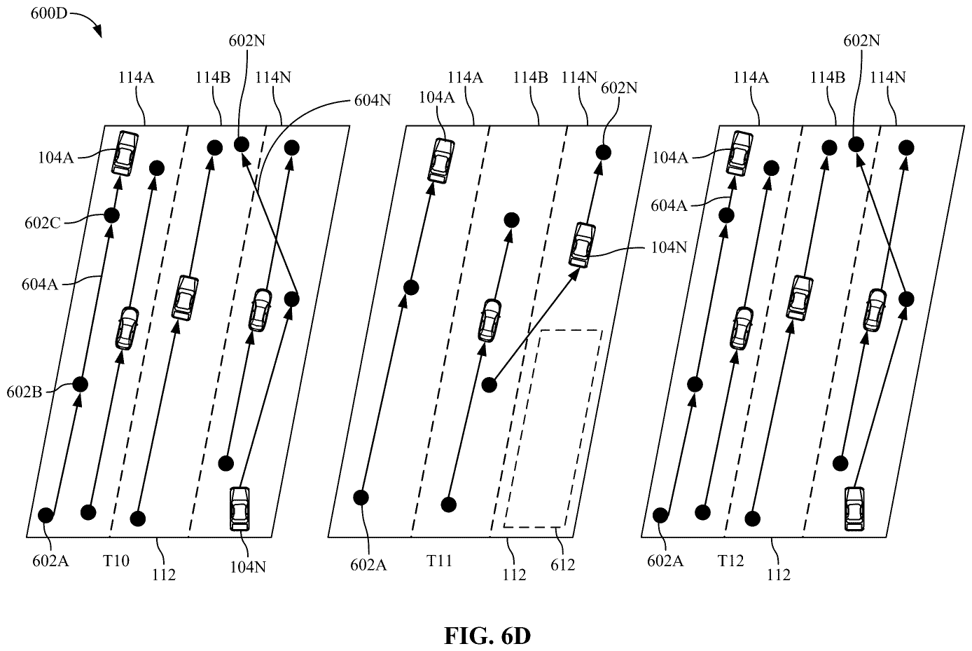

In an embodiment, the first percentage may be indicative of the presence of the road closure event on each portion of the road segment 112. In an embodiment, the first percentage may correspond to 100 percentage (%) to indicate the presence of the road closure event on each portion of the road segment 112. Accordingly, a diagram is provided with reference to FIG. 6A.

FIG. 6A is a first exemplary scenario 600A that depicts the road closure event associated with the road segment 112. FIG. 6A is explained in conjunction with elements from FIG. 1, FIG. 2, FIG. 3, FIG. 4A, FIG. 4B, FIG. 4C, FIG. 4D, FIG. 4E and FIG. 5. With reference to FIG. 6A, there is shown the set of vehicles 104, the road segment 112 that may include the set of lane segments 114, a set of trajectory points 602 associated with each vehicle of the set of vehicles 104, and a set of trajectories 604 associated with each vehicle of the set of vehicles 104. Further, the set of trajectory points 602 may include a first trajectory point 602A, a second trajectory point 602B, a third trajectory point 602C, up to Nth trajectory point 602N. The set of trajectories 604 may include a first trajectory 604A associated with the first vehicle 104A, a second trajectory 604B associated with the second vehicle 104B, up to an Nth trajectory associated with the Nth vehicle 104N. The first trajectory 604A may include the first trajectory point 602A, the second trajectory point 602B, and the third trajectory point 602C. Further, with reference to FIG. 6A, there is shown a first polygon 606 that may be indicative of the presence of the road closure event on each portion of the road segment 112 for the first time period denoted by T2. In an embodiment, the system 102 may be configured to render a presence of the set of trajectories 604 for a second time period denoted by T1 and a third time period denoted by T3. In an embodiment, the first time period T2 corresponds to the starting day of the road closure event on the road segment 112. The second time period T1 corresponds to a prior day from the starting day of the road closure event. For example, the prior day from the starting day of the road closure event may correspond to a day before the starting day of the road closure event, two days before the starting day of the road closure event, or 1 week before the starting day of the road closure event. In an embodiment, the third time period T3 corresponds to a successive day from the starting day of the road closure event. For example, the successive day corresponds to one day after the starting day of the road closure event, two days after the starting day of the road closure event, or 1 week after the starting day of the road closure event.

In an embodiment, the first percentage may be indicative of the presence of the road closure event on the at least one portion of the road segment 112. In an embodiment, the first percentage may correspond to 50% to indicate the presence of the road closure event on the at least one portion of the road segment 112. Accordingly, a diagram is provided with reference to FIG. 6B.

FIG. 6B is a second scenario 600B that depicts the road closure event associated with the at least one portion of the road segment 112, in accordance with an embodiment of the disclosure. FIG. 6B is explained in conjunction with elements from FIG. 1, FIG. 2, FIG. 3, FIG. 4A, FIG. 4B, FIG. 4C, FIG. 4D, FIG. 4E, FIG. 5, and FIG. 6A. With reference to FIG. 6B, there is shown the set of vehicles 104, the road segment 112 that may include the set of lane segments 114, the set of trajectory points 602 associated with each vehicle of the set of vehicles 104, and a set of trajectories 604 associated with each vehicle of the set of vehicles 104. Further, the set of trajectory points 602 may include the first trajectory point 602A, the second trajectory point 602B, the third trajectory point 602C, and up to the Nth trajectory point 602N. The set of trajectories 604 may include the first trajectory 604A associated with the first vehicle 104A, the second trajectory 604B associated with the second vehicle 104B, up to the Nth trajectory associated with the Nth vehicle 104N. The first trajectory 604A may include the first trajectory point 602A, the second trajectory point 602B, and the third trajectory point 602C. Further, with reference to FIG. 6B, there is shown a first polygon 608 that may be indicative of the presence of the road closure event on the at least one portion of the road segment 112 for the first time period denoted by T5. In an embodiment, the system 102 may be configured to render the presence of the set of trajectories 604 for the second time period denoted by T4 and a third time period denoted by T6. In an embodiment, the first time period T5, the second time period T4. and the third time period may correspond to the first time period T2, the second time period T1, and the third time period T3, respectively. Details about the first time period T2, the second time period T1, and the third time period T3 are explained in FIG. 6A.

In an embodiment, the first percentage may be indicative of the presence of the road closure event on at least one lane segment of the set of lane segments 114. The at least one lane segment is associated with the road segment 112. For example, the first percentage may correspond to 33.33% to indicate the presence of the road closure event on the at least one portion of the road segment 112. Accordingly, a diagram is provided with reference to FIG. 6C.

FIG. 6C is a third scenario 600C that depicts the road closure event associated with the at least one lane segment of the set of lane segments. FIG. 6C is explained in conjunction with elements from FIG. 1, FIG. 2, FIG. 3, FIG. 4A, FIG. 4B, FIG. 4C, FIG. 4D, FIG. 4E, FIG. 5, FIG. 6A, and FIG. 6B. With reference to FIG. 6C, there is shown the set of vehicles 104, the road segment 112 that may include the set of lane segments 114, the set of trajectory points 602 associated with each vehicle of the set of vehicles 104, and the set of trajectories 604 associated with each vehicle of the set of vehicles 104. Further, the set of trajectory points 602 may include the first trajectory point 602A, the second trajectory point 602B, the third trajectory point 602C, and up to the Nth trajectory point 602N. The set of trajectories 604 may include the first trajectory 604A associated with the first vehicle 104A, the second trajectory 604B associated with the second vehicle 104B, up to the Nth trajectory associated with the Nth vehicle 104N. The first trajectory 604A may include the first trajectory point 602A, the second trajectory point 602B, and the third trajectory point 602C. Further, with reference to FIG. 6C, there is shown a first polygon 610 that may be indicative of the presence of the road closure event on the at least one lane segment (such as the Nth lane segment 114N) of the set of lane segments 114 for a first time period denoted by T8. In an embodiment, the system 102 may be configured to render the presence of the set of trajectories 604 for the second time period denoted by T7 and the third time period denoted by T9. In an embodiment, the first time period T8, the second time period T7. and the third time period T9 may correspond to the first time period T2, the second time period T1, and the third time period T3, respectively. Details about the first time period T2, the second time period T1, and the third time period T3 are explained in FIG. 6A.

In an embodiment, the first percentage may be indicative of the presence of the road closure event on at one portion of the least one lane segment. The at least one lane segment is associated with the road segment 112. For example, the first percentage may correspond to 16.50% to indicate the presence of the road closure event on the at least one portion of the at least one lane segment. Accordingly, a diagram is provided with reference to FIG. 6D.

FIG. 6D is an exemplary scenario 600D that depicts the road closure event associated with the at least one lane segment of the set of lane segments. FIG. 6D is explained in conjunction with elements from FIG. 1, FIG. 2, FIG. 3, FIG. 4A, FIG. 4B, FIG. 4C, FIG. 4D, FIG. 4E, FIG. 5, FIG. 6A, FIG. 6B, and FIG. 6D. With reference to FIG. 6D, there is shown the set of vehicles 104, the road segment 112 that may include the set of lane segments 114, the set of trajectory points 602 associated with each vehicle of the set of vehicles 104, and the set of trajectories 604 associated with each vehicle of the set of vehicles 104. Further, the set of trajectory points 602 may include the first trajectory point 602A, the second trajectory point 602B, the third trajectory point 602C, and up to the Nth trajectory point 602N. The set of trajectories 604 may include the first trajectory 604A associated with the first vehicle 104A, the second trajectory 604B associated with the second vehicle 104B, up to the Nth trajectory associated with the Nth vehicle 104N. The first trajectory 604A may include the first trajectory point 602A, the second trajectory point 602B, and the third trajectory point 602C. Further, with reference to FIG. 6D, there is shown a first polygon 612 that may be indicative of the presence of the road closure event on the at least one portion of the at least one lane segment (such as the Nth lane segment 114N) for the first time period denoted by T11. The at least one portion of the at least one lane segment is associated with the road segment 112. In an embodiment, the system 102 may be configured to render the presence of the set of trajectories 604 for the second time period denoted by T10 and the third time period denoted by T12. In an embodiment, the first time period T11, the second time period T10, and the third time period T12 may correspond to the first time period T2, the second time period T1, and the third time period T3. Details about the first time period T2, the second time period T1, and the third time period T3 are explained in FIG. 6A.

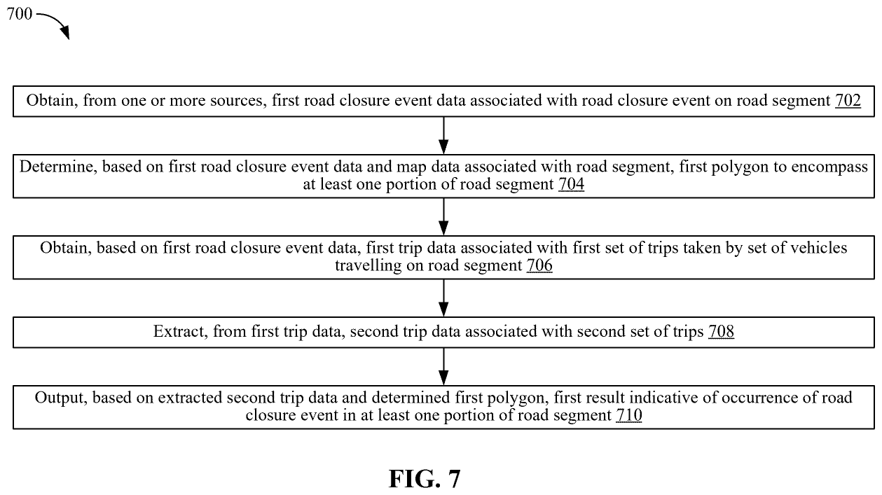

FIG. 7 is a flowchart 700 that illustrates a first exemplary method for validation of the road closure event on the road segment using the trip data, in accordance with an embodiment of the disclosure. FIG. 7 is explained in conjunction with elements from FIG. 1, FIG. 2, FIG. 3, FIG. 4A, FIG. 4B, FIG. 4C, FIG. 4D FIG. 4E, FIG. 5, FIG. 6, FIG. 6A, FIG. 6B, FIG. 6C, and FIG. 6D With reference to FIG. 7, there is shown the flowchart 700. The operations of the first exemplary method may be executed by any computing system, for example, by the system 102 of FIG. 1 or the processor 202 of FIG. 2. The operations of the flowchart 700 may start at 702.

At 702, the first road closure event data 118 associated with the road closure event on the road segment 112 may be obtained from one or more sources 124. In an embodiment, the system 102 may be configured to obtain the first road closure event data 118 associated with the road closure event on the road segment 112 from the one or more sources 124. In at least one embodiment, the processor 202 may be configured to obtain the first road closure event data 118 associated with the road closure event on the road segment 112 from the one or more sources 124. Details about the acquisition of the first road closure event data 118 are provided, for example, in FIG. 1 and at 302 in FIG. 3.

At 704, the first polygon 116 to encompass the at least one portion of the road segment 112 may be determined based on the first road closure event data 118 and the map data 122 associated with the road segment 112. In an embodiment, the system 102 may be configured to determine the first polygon 116 to encompass the at least one portion of the road segment 112 based on the first road closure event data 118 and the map data 122 associated with the road segment 112. In at least one embodiment, the processor 202 may be configured to determine the first polygon 116 to encompass at least one portion of the road segment 112 based on the first road closure event data 118 and the map data 122 associated with the road segment 112. Details about the determination of the first polygon 116 are provided, for example, at 304 in FIG. 3 and FIG. 4B.

At 706, the first trip data 120 associated with the first set of trips taken by the set of vehicles 104 traveling on the road segment 112 may be obtained based on the first road closure event data 118. In an embodiment, the system 102 may be configured to obtain the first set of trips taken by the set of vehicles 104 traveling on the road segment 112 based on the first road closure event data 118. In at least one embodiment, the processor 202 may be configured to obtain the first set of trips taken by the set of vehicles 104 traveling on the road segment 112 based on the first road closure event data 118. Details about the acquisition of the first trip data 120 are provided, for example, at 302 in FIG. 3.

At 708, the second trip data associated with the second set of trips may be extracted from the first trip data 120. In an embodiment, the system 102 may be configured to extract the second trip data associated with the second set of trips from the first trip data 120. In at least one embodiment, the processor 202 may be configured to obtain the second trip data associated with the second set of trips may be extracted from the first trip data 120. Details about the extraction of the second trip data are provided, for example, at 306 in FIG. 3.

At 710, the first result indicative of the occurrence of the road closure event in the at least one portion of the road segment 112 may be outputted based on the extracted second trip data and the determined first polygon 116. In an embodiment, the system 102 may be configured to output the first result indicative of the occurrence of the road closure event in the at least one portion of the road segment 112 based on the extracted second trip data and the determined first polygon 116. In at least one embodiment, the processor 202 may be configured to output the first result indicative of the occurrence of the road closure event in the at least one portion of the road segment 112 based on the extracted second trip data and the determined first polygon 116. Details about the output of the first result are provided, for example, at 318 in FIG. 3.

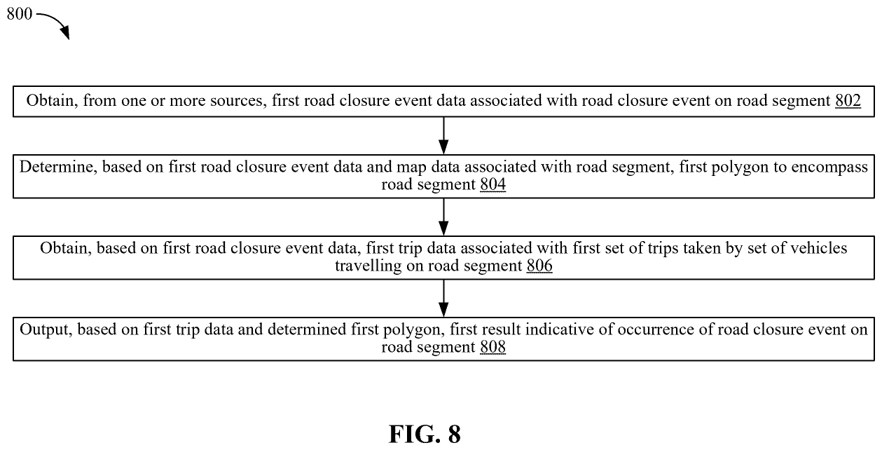

FIG. 8 is a flowchart 800 that illustrates a second exemplary method for validation of the road closure event on the road segment using the trip data, in accordance with an embodiment of the disclosure. FIG. 8 is explained in conjunction with elements from FIG. 1, FIG. 2, FIGS. 3, 4A, FIG. 4B, FIG. 4C, FIG. 4D FIG. 4E, FIG. 5, FIG. 6, FIG. 6A, FIG. 6B, FIG. 6C, FIG. 6D, and FIG. 7. With reference to FIG. 8, there is shown the flowchart 800. The operations of the first exemplary method may be executed by any computing system, for example, by the system 102 of FIG. 1 or the processor 202 of FIG. 2. The operations of the flowchart 800 may start at 802.

At 802, the first road closure event data 118 associated with the road closure event on the road segment 112 may be obtained from one or more sources 124. In an embodiment, the system 102 may be configured to obtain the first road closure event data 118 associated with the road closure event on the road segment 112 from the one or more sources 124. In at least one embodiment, the processor 202 may be configured to obtain the first road closure event data 118 associated with the road closure event on the road segment 112 from the one or more sources 124. Details about the acquisition of the first road closure event data 118 are provided, for example, in FIG. 1 and at 302 in FIG. 3.

At 804, the first polygon 116 to encompass the road segment 112 may be determined based on the first road closure event data 118 and the map data 122 associated with the road segment 112. In an embodiment, the system 102 may be configured to determine the first polygon 116 to encompass the road segment 112 based on the first road closure event data 118 and the map data 122 associated with the road segment 112. In at least one embodiment, the processor 202 may be configured to determine the first polygon 116 to encompass the road segment 112 may be determined based on the first road closure event data 118 and the map data 122 associated with the road segment 112. Details about the determination of the first polygon 116 are provided, for example, at 304 in FIG. 3 and FIG. 4B.

At 806, the first trip data 120 associated with the first set of trips taken by the set of vehicles 104 traveling on the road segment 112 may be obtained based on the first road closure event data 118. In an embodiment, the system 102 may be configured to obtain the first set of trips taken by the set of vehicles 104 traveling on the road segment 112 based on the first road closure event data 118. In at least one embodiment, the processor 202 may be configured to obtain the first set of trips taken by the set of vehicles 104 traveling on the road segment 112 based on the first road closure event data 118. Details about the acquisition of the first trip data 120 are provided, for example, at 302 in FIG. 3.

At 808, the first result indicative of the occurrence of the road closure event on the road segment 112 may be outputted based on the first trip data 120 and the determined first polygon 116. In an embodiment, the system 102 may be configured to output the first result indicative of the occurrence of the road closure event on the road segment 112 may be outputted based on the first trip data 120 and the determined first polygon 116. In at least one embodiment, the processor 202 may be configured to output the first result indicative of the occurrence of the road closure event on the road segment 112 may be outputted based on the first trip data 120 and the determined first polygon 116. Details about the output of the first result are provided, for example, at 316 in FIG. 3.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe examples in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A system, comprising:
a memory to store computer-executable instructions; and
one or more processors coupled to the memory, wherein the one or more processors are configured to:
obtain, from one or more sources, first road closure event data associated with a road closure event on a road segment;
determine, based on the first road closure event data and map data associated with the road segment, a first polygon to encompass at least one portion of the road segment;
obtain, based on the first road closure event data, first trip data associated with a first set of trips taken by a set of vehicles traveling on the road segment, wherein each trip of the first set of trips is associated with the road segment;
extract, from the first trip data, second trip data associated with a second set of trips, wherein each trip of the second set of trips is associated with the at least one portion of the road segment; and
output, based on the extracted second trip data and the determined first polygon, a first result indicative of an occurrence of the road closure event in the at least one portion of the road segment.

2. The system of claim 1, wherein the one or more processors are further configured to:
apply a set of geometric operations on the extracted second trip data and the determined first polygon;
determine first trajectory data associated with a first set of trajectories of the set of vehicles based on the application of the set of geometric operations on the extracted second trip data and the determined first polygon, wherein each trajectory of the first set of trajectories is associated with the at least one portion of the road segment;
determine, based on the first trajectory data, validation data associated with the road closure event on the road segment;
validate the first road closure event data based on a comparison of the first road closure event data with the validation data; and
determine the first result based on the validation of the first road closure event data.

3. The system of claim 2, wherein the one or more processors are further configured to:
generate a shape file based on the determined first polygon, wherein the shape file comprises a set of geometry attributes associated with a geometry of the determined first polygon; and
determine the first trajectory data based on an application of the set of geometric operations on the extracted second trip data and the set of geometry attributes.

4. The system of claim 2, wherein the set of geometric operations comprises at least one of a polygon geometry overlay operation, a spatial join operation, or an intersection operation.

5. The system of claim 2, wherein the one or more processors are configured to:
determine, based on at least the first trajectory data, a first confidence score associated with the first result, wherein the first confidence score is indicative of a likelihood that the first result is correct; and
output the first result based on a comparison of the first confidence score with a predefined confidence score.

6. The system of claim 1, wherein the one or more processors are further configured to:
determine first trajectory data associated with a first set of trajectories of the set of vehicles based on the application of the set of geometric operations on the extracted second trip data and the determined first polygon;
determine, based on the first trajectory data, an intermediate result for a first time period, wherein the intermediate result is indicative of an occurrence of the trajectories in the at least one portion of the road segment for a first time period; and
determine, based on the determination that the intermediate result is indicative of an absence of the trajectories in the at least one portion of the road segment for the first time period, the first result indicative of a presence of the road closure event in the at least one portion of the road segment for the first time period.

7. The system of claim 6, wherein the one or more processors are further configured to:
determine, based on the determination that the first result is indicative of the presence of the road closure event in the at least one portion of the road segment for the first time period, a first percentage indicative of an area associated with the at least one portion of the road segment.

8. The system of claim 7, wherein the one or more processors are further configured to:
determine the first percentage based on the first trajectory data, wherein the first trajectory data comprises at least one of a count of trajectories in the first set of trajectories, a location of each vehicle of the set of vehicles in the at least one portion of the road segment, temporal data associated with each trajectory of the first set of trajectories, or a speed of each vehicle of the set of vehicles on the at least one portion of the road segment.

9. The system of claim 6, wherein the one or more processors are further configured to:
determine, based on the determination of that the intermediate result is indicative of a presence of the trajectories in the at least one portion of the road segment for the first time period, the first result indicative of an absence of the road closure event in the at least one portion of the road segment for the first time period.

10. A method, comprising:
obtaining, from one or more sources, first road closure event data associated with a road closure event on a road segment;
determining, based on the first road closure event data and map data associated with the road segment, a first polygon to encompass at least one portion of the road segment;
obtaining, based on the first road closure event data, first trip data associated with a first set of trips taken by a set of vehicles traveling on the road segment, wherein each trip of the first set of trips is associated with the road segment;
extracting, from the first trip data, second trip data associated with a second set of trips, wherein each trip of the second set of trips is associated with the at least one portion of the road segment; and
outputting, based on the extracted second trip data and the determined first polygon, a first result indicative of an occurrence of the road closure event in the at least one portion of the road segment.

11. The method of claim 10, further comprising:
applying a set of geometric operations on the extracted second trip data and the determined first polygon;
determining first trajectory data associated with a first set of trajectories of the set of vehicles based on the application of the set of geometric operations on the extracted second trip data and the determined first polygon, wherein each trajectory of the first set of trajectories is associated with the at least one portion of the road segment;
determining, based on the first trajectory data, validation data associated with the road closure event on the road segment;
validating the first road closure event data based on a comparison of the first road closure event data with the validation data; and
determining the first result based on the validation of the first road closure event data.

12. The method of claim 11, further comprising:
generating a shape file based on the determined first polygon, wherein the shape file comprises a set of geometry attributes associated with a geometry of the determined first polygon; and
determining the first trajectory data based on an application of the set of geometric operations on the extracted second trip data and the set of geometry attributes.

13. The method of claim 11, wherein the set of geometric operations comprises at least one of a polygon geometry overlay operation, a spatial join operation, or an intersection operation.

14. The method of claim 11, further comprising:
determining, based on at least the first trajectory data, a first confidence score associated with the first result, wherein the first confidence score is indicative of a likelihood that the first result is correct; and
outputting the first result based on a comparison of the first confidence score with a predefined confidence score.

15. The method of claim 11, further comprising:
determining, based on the first trajectory data, an intermediate result for a first time period, wherein the intermediate result is indicative of an occurrence of the trajectories in the at least one portion of the road segment for a first time period; and
determining, based on the determination that the intermediate result is indicative of an absence of the trajectories in the at least one portion of the road segment for the first time period, the first result indicative of a presence of the road closure event in the at least one portion of the road segment for the first time period.

16. The method of claim 15, further comprising:
determining, based on the determination that the first result is indicative of the presence of the road closure event in the at least one portion of the road segment for the first time period, a first percentage indicative of an area associated with the at least one portion of the road segment.

17. The method of claim 16, further comprising:
determining the first percentage based on the first trajectory data, wherein the first trajectory data comprises at least one of a count of trajectories in the first set of trajectories, a location of each vehicle of the set of vehicles in the at least one portion of the road segment, temporal data associated with each trajectory of the first set of trajectories, or a speed of each vehicle of the set of vehicles on the at least one portion of the road segment.

18. The method of claim 15, further comprising:
determining, based on the determination of that the intermediate result is indicative of a presence of the trajectories in the at least one portion of the road segment for the first time period, the first result indicative of an absence of the road closure event in the at least one portion of the road segment for the first time period.

19. A non-transitory computer-readable storage medium having computer programmable code instructions stored therein, the computer program code instructions, when executed by one or more processors, cause the one or more processors to:
obtain, from one or more sources, first road closure event data associated with a road closure event on a road segment;
determine, based on the first road closure event data and map data associated with the road segment, a first polygon to encompass the road segment;
obtain, based on the first road closure event data, first trip data associated with a first set of trips taken by a set of vehicles traveling on the road segment, wherein each trip of the first set of trips is associated with the road segment; and
output, based on the first trip data and the determined first polygon, a first result indicative of an occurrence of the road closure event on the road segment.

20. The non-transitory computer-readable storage medium of claim 19, the computer program code instructions, when executed by the one or more processors, further cause the one or more processors to:
apply a set of geometric operations on the first trip data and the determined first polygon;
determine first trajectory data associated with a first set of trajectories of the set of vehicles based on an application of the set of geometric operations on the first trip data and the determined first polygon, wherein each trajectory of the first set of trajectories is associated with the road segment;
determine, based on the first trajectory data, validation data associated with the road closure event on the road segment;
validate the first road closure event data based on a comparison of the first road closure event data with the validation data; and
determine the first result based on the validation of the first road closure event data.
